(19) United States
(12) Patent Application Publication
(10) Pub. No.: US 2026/0171264 A1
(43) Pub. Date: Jun. 18, 2026

(54) Statistical Fusion Energy System with Staged Magnetic Micro-Chambers and Dynamic Plasma Transfer Valves

(71) Applicant: Leon Rivkin, Old Brookville, NY (US)

(72) Inventor: Leon Rivkin, Old Brookville, NY (US)

(21) Appl. No.: 19/419,272

(22) Filed: Dec. 15, 2025

Related U.S. Application Data
(60) Provisional application No. 63/734,150, filed on Dec. 15, 2024.
(60) Provisional application No. 63/735,936, filed on Dec. 19, 2024.
(60) Provisional application No. 63/740,411, filed on Dec. 31, 2024.

(51) Int. Cl. G21B 1/05; G21D 3/00

(52) U.S. Cl. CPC G21B 1/05; G21D 3/007

(57) ABSTRACT

A fusion energy system is provided employing staged magnetic micro-chambers with dynamically reconfigurable magnetic valves for plasma transfer. Multiple plasma acceleration channels, each containing a series of magnetic confinement regions defined by quasi-closed flux surfaces, converge on a microscale collision zone. Each micro-chamber operates in a confinement mode with closed magnetic topology or a valve mode with transiently opened flux channels that may be understood as time-gated weak points or breach zones in the confining field. Plasma packets are sequentially compressed and transferred between chambers as collimated jets driven by pressure differentials through narrow valve throats formed by coordinated driver and trim coil current changes. A matrix-based control system specifies pre-compensated valve timing and coil commands with picosecond-scale resolution without requiring plasma state feedback during operating cycles, with cycle-to-cycle learning based on external magnetic and fusion output sensors.

### CROSS-REFERENCE TO RELATED APPLICATIONS

This application claims the benefit of priority under 35 U.S.C. § 119 (e) to U.S. Provisional Patent Application No. 63/734,150, filed on Dec. 15, 2024, entitled “SYSTEM AND METHOD FOR CONTINUOUS STATISTICAL FUSION ENERGY GENERATION USING MAGNETICALLY GUIDED PLASMA STREAMS,” the entire disclosure of which is hereby incorporated by reference in its entirety for all purposes.

This application is related to, and claims the benefit of, the following co-pending U.S. Provisional Patent Applications filed by the present inventor, each of which is incorporated by reference in its entirety:
(a) U.S. Provisional Patent Application No. 63/735,936, filed on Dec. 19, 2024, entitled “Ultra-Fast, High-Current Electron Beam Source with Integrated Capacitive Energy Storage,” which discloses ultra-fast, high-current electron beam auxiliary drivers for fusion and high-energy plasma systems; and
(b) U.S. Provisional Patent Application No. 63/740,411, filed on Dec. 31, 2024, entitled “REAL-TIME INTELLIGENT CONTROL SYSTEM-ON-CHIP (SoC) WITH DUAL-STAGE PROCESSING AND FLEXIBLE I/O INTERFACING,” which discloses real-time intelligent control System-on-Chip (“SoC”) or “Brain-on-Chip” architectures for matrix-based control of pulsed magnetic and plasma systems.

The present application is also related to additional applications that may be filed from the same portfolio concerning digital control, diagnostic, and energy-handling subsystems for fusion and high-energy plasma devices.

The disclosures of such related applications, to the extent they exist and to the extent not inconsistent herewith, are hereby incorporated by reference for all purposes.

### STATEMENT REGARDING FEDERALLY SPONSORED RESEARCH OR DEVELOPMENT

The subject matter described herein was not made under, and is not subject to, any contract, grant, or award with any agency of the United States Government.

### BACKGROUND OF THE DISCLOSURE

### Field of the Disclosure

The present application relates generally to fusion energy generation systems and magnetically confined plasma devices.

More particularly, the application relates to pulsed or cyclic fusion systems that employ magnetically defined micro-chambers, programmable magnetic field topologies, and controlled plasma transfer events between such chambers to produce convergent plasma collisions in a central interaction region.

In certain embodiments, the application provides a statistical fusion engine in which many rapid, low-yield collision events are accumulated over time, rather than relying on continuous, steady-state confinement or a single high-gain burn.

### Description of Related Art

### Magnetic Confinement Approaches

Magnetic confinement fusion systems such as tokamaks and stellarators have been extensively investigated as candidates for commercial fusion power. Tokamak devices (for example, large experimental machines such as JET and ITER) confine a toroidal plasma using strong toroidal and poloidal magnetic fields, often generated by superconducting coils, and rely on real-time feedback control of plasma position, shape, and stability. Stellarators, such as Wendelstein 7-X, employ complex three-dimensional magnet geometries to create steady-state confining fields without large plasma currents.

These approaches are characterized by very large physical scale, high magnetic field strengths generated by superconducting magnets, and significant engineering complexity. Critically, they are designed around the assumption that plasma must be maintained in a stable, high-performance equilibrium state, requiring continuous real-time measurement of plasma temperature, density, and position, and rapid feedback adjustment of confining fields to suppress instabilities. Manufacturing tolerances for magnet systems are typically extremely tight, often requiring millimeter-scale precision over structures spanning tens of meters. Achieving net energy at practical cost and size remains a substantial challenge, in part because these architectures treat any departure from equilibrium as a failure condition requiring immediate correction.

### Inertial Confinement Approaches

Inertial confinement fusion (ICF) systems use intense, short-duration driver pulses to rapidly compress small fuel targets to fusion conditions. Laser-driven ICF facilities, such as those employing multi-megajoule laser systems, direct a large number of beams onto a small pellet in either direct or indirect drive geometries. The compressed fuel is intended to ignite and burn before it can disassemble.

While ICF has demonstrated very high instantaneous fusion power during single shots, such systems typically operate at very low repetition rates and require massive driver infrastructure and precise, often complex, target fabrication. Scaling these one-shot or low-duty-cycle systems to continuous power production with acceptable economics remains unresolved, in part due to the difficulty of achieving both high gain and high repetition rate. These systems are designed around the assumption that each shot must be individually optimized for maximum yield, as the interval between shots is too long for statistical accumulation of many low-yield events.

### Alternative Magnetic Approaches

A variety of alternative magnetic fusion concepts have been explored to address the challenges of large tokamaks and laser ICF. Field-reversed configuration (FRC) devices form compact toroidal or spheromak-like plasmoids and may use neutral beam injection or other methods for sustainment and heating; some recent work has applied advanced control algorithms and high-speed feedback to manage FRC stability. Magnetized target fusion concepts inject one or more magnetized plasma structures into a compression region, which may be surrounded by a mechanically driven liquid metal or solid liner. Inertial electrostatic confinement (IEC) devices and colliding beam concepts such as Migma rely on electrostatic or magnetic focusing of ions into a central region, often operating in regimes where fusion reactions occur statistically as ions make many passes.

These alternative approaches illustrate a broad design space that includes pulsed operation, magnetized plasmoids, and statistical collision processes. However, even in pulsed or statistical systems, known designs generally assume that detailed real-time knowledge of plasma state is necessary to achieve acceptable performance, and they typically employ either relatively few large plasma structures per pulse or continuous ion beams rather than discrete staged plasma packets.

No known system describes a chain of small, localized magnetic confinement regions (micro-chambers) linked by programmable, time-gated magnetic transfer valves that stage many discrete plasma packets toward a common collision zone through sequential compression events.

### Colliding Plasma Concepts

Colliding plasma and colliding beam fusion concepts seek to achieve fusion through the head-on interaction of two or more directed plasma flows or ion beams. Examples include devices that launch opposing plasmoids along a common axis for merger and compression, systems that form converging plasma jets to create a central liner, and converging beam electrostatic devices in which multiple ion guns or grid structures direct ions into a small central volume. Experimental plasma liner work has demonstrated the convergence of many discrete jets toward a central region, and various patents describe converging beam systems with some degree of recirculation or reuse of unreacted particles. Recent proposals have suggested splitting an existing plasma torus into two rings and accelerating them toward collision, relying on momentum after release rather than continuous magnetic control during the collision phase.

These systems demonstrate that convergent flow and collision can produce locally enhanced densities and temperatures suitable for fusion. However, they generally use either a single compression or collision stage per pulse, relatively simple magnetic topologies with static (rather than dynamically reconfigurable) field structures, or they release plasma from magnetic control prior to collision.

Existing colliding plasma concepts do not provide multi-stage magnetic micro-chamber chains with time-gated magnetic valves between stages, nor do they describe architectures in which plasma remains under active magnetic guidance through a sequence of staged compression and transfer events culminating in a controlled microscale collision.

### Limitations of Prior Art

Broadly, prior fusion approaches can be grouped into two categories: those that attempt to maintain a large, continuous plasma in a stable, high-performance state for as long as possible, and those that attempt to achieve very high gain in a small number of discrete compression events. Both categories typically assume that each operating period or shot should be individually optimized and that deviations from ideal conditions are failures to be minimized.

Prior systems do not disclose a fusion architecture that treats the plasma path as a sequence of localized magnetic micro-chambers, each acting as a temporary containment and compression cell, nor do they disclose programmable, time-gated magnetic topology changes that act as valves to transfer plasma between such chambers as collimated jets. Known control schemes for fusion devices generally focus on maintaining equilibrium or optimizing a single compression event, rather than on pre-computed, open-loop control of magnetic topology within each cycle combined with cycle-to-cycle adaptation at high repetition rates.

There remains a need for fusion systems that can operate effectively in the presence of manufacturing and control imperfections, that avoid reliance on continuous real-time plasma state feedback within each operating cycle, that employ programmable magnetic topology to create discrete transfer events between staged confinement regions, and that achieve net energy output by statistically accumulating the contributions of many rapid collision events rather than optimizing individual shots for maximum yield. The present application addresses these needs.

### SUMMARY OF THE DISCLOSURE

It is an object of the present application to provide a staged plasma acceleration and compression architecture based on a plurality of magnetic micro-chambers, each configured to act as a localized confinement and pressure reservoir.

It is a further object of the application to provide dynamically reconfigurable magnetic field configurations that act as transient plasma transfer valves between adjacent micro-chambers, forming collimated jets when opened and restoring confinement when closed.

It is another object of the application to coordinate multiple such staged channels so that final plasma jets converge into a microscale collision region, producing fusion reactions in a sequence of transient collision events rather than requiring a single, long-lived plasma state.

It is an additional object of the application to implement coil and valve control using pre-computed control matrices and synchronized driver electronics, executing each operating cycle in an open-loop fashion with respect to plasma state while allowing cycle-to-cycle adaptation based on external measurements of magnetic fields and fusion output.

It is also an object of the application to provide a fusion energy generation system that does not require continuous, real-time measurement and feedback control of plasma temperature, density, or position during each operating cycle.

These and other objects of the application are achieved by systems and methods that employ staged magnetic micro-chambers, dynamically reconfigurable magnetic transfer valves, and matrix-based, open-loop control of magnetic topology to implement a high-repetition statistical fusion engine. In representative embodiments, the system maintains precise, repeatable magnetic configurations and valve timing without requiring continuous real-time measurement of plasma temperature, density, or position within each operating cycle.

In some embodiments, it is an object of the application to support practical manufacturing tolerances and robust operation by relying on magnetic field shaping and digital control rather than extreme mechanical precision, and to permit integration into modular fusion units suitable for distributed or scalable power generation.

In one aspect, the application provides a fusion energy system comprising a plurality of plasma acceleration channels arranged to direct plasma toward a central collision region. Each channel includes a series of magnetic micro-chambers, where each micro-chamber is defined by substantially closed magnetic flux surfaces and configured to confine a plasma packet during a confinement phase. A magnetic field system associated with each micro-chamber is operable in at least two modes: a confinement mode (also referred to as “Mode 1”), in which the flux surfaces remain closed and plasma is retained in the micro-chamber, and a valve mode (also referred to as “Mode 2”), in which coil currents are transiently modified to reconfigure the magnetic topology and create a narrow open-flux channel between adjacent regions.

When a micro-chamber is switched into the valve mode, plasma confined at elevated pressure in that chamber is expelled through the open channel as a collimated jet directed into a downstream micro-chamber or into a central collision region. By sequencing such valve events between successive micro-chambers, the system implements staged acceleration and compression of discrete plasma packets along each channel. The final micro-chambers in multiple channels are coupled to the central collision region via similar magnetic valves, and a control system coordinates the opening of these terminal valves so that the resulting plasma jets arrive at the collision region in close temporal alignment, forming a convergent collision wavefront in a microscale volume.

In another aspect, the application provides a control architecture in which the time-dependent behavior of the coil currents and valve states is specified by one or more pre-computed control matrices. Each matrix may index coils or coil groups against discrete time segments within an operating cycle and store commanded current values or state transitions. A timing distribution network, such as a phase-locked clock and synchronized digital drivers, ensures that these commands are applied to the coils with nanosecond-scale precision across many channels. Within each cycle, the system executes the coil commands in an open-loop manner without relying on real-time plasma diagnostics; between cycles, the control matrices may be adjusted based on external measurements of magnetic fields, fusion yield, and energy output to improve overall performance.

In some embodiments, the control matrices encode not only target current amplitudes and valve states but also time-advanced command patterns that compensate for known response times of coils and driver hardware. By combining a high-resolution master clock with pre-calculated lead and lag offsets for each actuator, the system can schedule current changes in advance of desired effective magnetic field changes so that topological transitions, such as the opening and closing of micro-valves at specified spatial locations, occur within tight timing windows even though the underlying current ramps extend over nanosecond or longer time scales.

In a further aspect, the application provides a statistical fusion operating regime in which large numbers of such staged collision cycles are executed at high repetition rate, typically exceeding one hundred and preferably exceeding one thousand cycles per second. Individual collision events need not achieve high gain or even a particular minimum yield; in representative embodiments, per-cycle fusion success rates may be less than ten percent and in some cases less than one percent, and in some designs even less than about 0.1 percent or 0.01 percent, provided that aggregate fusion energy output over many cycles exceeds aggregate input energy. Instead, net positive energy is achieved by accumulating the contributions of many rapid, low-to-moderate yield events and by recovering energy from the resulting plasma and fusion products using conventional energy-handling systems. In some embodiments, exhaust valves employing the same magnetic topology reconfiguration mechanism direct fusion products and residual plasma to energy recovery structures, with some pathways returning unburned plasma to earlier stages for reuse. The staged micro-chamber and magnetic valve architecture is specifically designed to support such high repetition rates while avoiding the need for continuous, high-precision plasma control.

In accordance with a first aspect of the present application, a fusion energy system is provided, the fusion energy system comprising: a plurality of plasma acceleration channels, each channel defining a plasma transport axis extending from an upstream injection region toward a central collision region; for each plasma acceleration channel, a plurality of magnetic micro-chambers arranged in series along the plasma transport axis, each magnetic micro-chamber being defined principally by closed or quasi-closed magnetic flux surfaces configured to confine a plasma packet during a confinement phase; a magnetic field system comprising a plurality of base coils, driver coils, and trim coils arranged with respect to the plasma acceleration channels and configured, when energized, to: generate the closed or quasi-closed magnetic flux surfaces that define the magnetic micro-chambers during the confinement phase; and selectively reconfigure a portion of the magnetic flux surfaces at a boundary of a given magnetic micro-chamber to form a transient open-flux channel between the given magnetic micro-chamber and an adjacent region during a valve-open phase; a control system operatively coupled to the magnetic field system and configured to drive the base coils, driver coils, and trim coils according to pre-defined time-dependent control sequences so that, during the valve-open phase, plasma confined in the given magnetic micro-chamber is expelled through the transient open-flux channel as a collimated plasma jet into the adjacent region; and the central collision region magnetically coupled to terminal ones of the magnetic micro-chambers of the plurality of plasma acceleration channels and configured to receive collimated plasma jets from the terminal magnetic micro-chambers during coordinated valve-open phases, such that the collimated plasma jets converge within a localized interaction volume to produce fusion reactions.

In various embodiments of the fusion energy system of the first aspect of the application, the plasma acceleration channel may comprise at least three magnetic micro-chambers arranged in series.

In additional or alternative embodiments of the fusion energy system of the first aspect of the application, an axial length of each magnetic micro-chamber along the plasma transport axis can be between about 1 centimeter and about 20 centimeters, and a transverse dimension of each magnetic micro-chamber can be between about 0.5 centimeters and about 5 centimeters.

In additional or alternative embodiments of the fusion energy system of the first aspect of the application, the transient open-flux channel formed during the valve-open phase can have an effective cross-sectional area that is less than about thirty-five percent of a cross-sectional area of the corresponding magnetic micro-chamber, such that plasma is expelled as a narrow, directed jet. The valve-open phase at a given magnetic micro-chamber boundary may have a duration in a range from about 10 nanoseconds to about 10 microseconds.

In embodiments of the fusion energy system of the first aspect of the application, the collimated plasma jets produced during the valve-open phases have directed velocities along the plasma transport axes of at least about 10 kilometers per second.

In additional or alternative embodiments of the fusion energy system of the first aspect of the application, the control system may comprise: a control matrix storage module containing one or more control matrices that index actuators, including coils and valve abstractions, against discrete time slices within an operating cycle, each control matrix entry specifying a target value or state for a corresponding actuator at a corresponding time slice; a timing distribution network configured to distribute a master clock signal to a plurality of coil driver channels with bounded skew; and a cycle execution module configured to read entries of the one or more control matrices in synchronization with the master clock signal and to issue commands to the coil driver channels such that valve-open phases and associated coil transitions across multiple magnetic micro-chambers occur in predetermined temporal relationships. Entries of the one or more control matrices encode time-advanced drive commands that compensate for measured or modeled response times of the coils and driver hardware so that effective magnetic topology changes at specified spatial locations occur within targeted timing windows. The control system is configured to execute each operating cycle according to the pre-defined time-dependent control sequences without relying on intra-cycle measurement of plasma temperature, plasma density, or plasma position within the magnetic micro-chambers or the central collision region. The control system may be further configured to: receive, between operating cycles, diagnostic data from external sensors including at least one of magnetic field sensors, driver current sensors, and fusion output detectors; and adjust one or more of the pre-defined time-dependent control sequences for subsequent operating cycles based at least in part on the diagnostic data, thereby implementing cycle-to-cycle adaptation while maintaining open-loop control with respect to plasma state during each operating cycle.

In various embodiments of the system of the first aspect of the application, the central collision region may have a linear dimension less than about one millimeter, and the control system is configured to coordinate valve-open phases at terminal magnetic micro-chambers of the plurality of plasma acceleration channels so that peak intensities of collimated plasma jets from different channels overlap in the central collision region within a temporal window in a range from about 1 nanosecond to about 1 microsecond.

In embodiments of the fusion energy system of the first aspect of the application, the system is capable of being operated in repeated operating cycles at a repetition rate of at least about 1 operating cycle per second, and is configured such that aggregate fusion energy output over a plurality of the repeated operating cycles exceeds aggregate energy input to the fusion energy system over the plurality of operating cycles. The control system may be further configured to adjust the repetition rate of the operating cycles over a range spanning at least one order of magnitude. Net positive aggregate fusion energy output can be achievable without requiring that a majority of individual operating cycles each produce net-positive fusion energy output, including operating regimes in which more than 90 percent, and in some implementations more than 99 percent, of individual operating cycles do not themselves produce fusion energy output greater than an energy input to the fusion energy system for the respective operating cycles.

In various further embodiments of the system of the first aspect of the application, the system may further comprise one or more exhaust regions magnetically coupled to selected magnetic micro-chambers or to the central collision region by exhaust-type transient open-flux channels formed by corresponding exhaust valves, the exhaust regions being arranged to receive plasma and fusion products during an exhaust phase of the operating cycle. At least a portion of the exhaust regions can be thermally coupled to energy-handling subsystems configured to convert thermal energy carried by exhaust plasma and fusion products into usable heat or electrical power. The system may further comprise recycling paths configured to route a fraction of exhaust plasma for reinjection into upstream regions of one or more plasma acceleration channels. Magnetic configurations near the exhaust valves may include engineered weak points configured to promote plasma detachment and outflow when the exhaust valves are opened.

In implementations of the system of the first aspect of the application, the system may be implemented as a modular fusion unit configured to operate in parallel with one or more additional modular fusion units on a common electrical or thermal bus, each modular fusion unit comprising its own plurality of plasma acceleration channels, coil and driver hardware, local control system, and exhaust regions, such that aggregate power output of a plant is scalable by adding or removing modular fusion units.

In embodiments of the system of the first aspect of the application, the plurality of plasma acceleration channels may comprise between three and twelve plasma acceleration channels arranged around the central collision region.

In still further embodiments of the fusion energy system of the first aspect of the application, the base coils are configured to provide a background guiding magnetic field along the plasma transport axes; the driver coils are positioned at boundaries between adjacent magnetic micro-chambers and are configured to generate axial field gradients defining the magnetic micro-chamber boundaries; and the trim coils are configured to generate localized field perturbations for fine shaping of flux surfaces and for forming valve throats during valve-open phases.

In various embodiments of the fusion energy system of the present application, the system may further comprise guide structures surrounding the plasma acceleration channels, the guide structures having internal apertures at least five times larger than a transverse dimension of plasma packets confined within the magnetic micro-chambers.

In still other embodiments of the fusion energy system of the present application, the control system may be configured to operate the magnetic micro-chambers in a pipelined fashion such that, at a given time within an operating cycle, different plasma packets occupy different magnetic micro-chambers along a plasma acceleration channel, each at a different phase of a confinement-valve-transfer sequence.

In additional or alternative embodiments of the fusion energy system of the first aspect of the application, the transient open-flux channel formed during the valve-open phase may comprise a localized, time-gated weak point or breach zone in the magnetic flux surfaces at the boundary of the given magnetic micro-chamber.

In accordance with a second aspect of the present application, a method of generating fusion energy is provided, the method comprising: providing a plurality of plasma acceleration channels, each channel including a plurality of magnetic micro-chambers arranged in series along a plasma transport axis, and a central collision region magnetically coupled to terminal ones of the magnetic micro-chambers; in an operating cycle, injecting plasma into an upstream magnetic micro-chamber of at least one of the plasma acceleration channels; during a confinement phase for a given magnetic micro-chamber, energizing a magnetic field system to generate closed or quasi-closed magnetic flux surfaces that confine the plasma within the given magnetic micro-chamber as a plasma packet; during a valve-open phase for a boundary of the given magnetic micro-chamber, transiently reconfiguring the magnetic field system to form an open-flux channel between the given magnetic micro-chamber and an adjacent region, while maintaining confinement elsewhere in the given magnetic micro-chamber; expelling at least a portion of the confined plasma from the given magnetic micro-chamber through the open-flux channel as a collimated plasma jet into the adjacent region; repeating the confinement and expelling steps through successive pairs of magnetic micro-chambers in at least one of the plasma acceleration channels so that the plasma packet is staged through multiple magnetic micro-chambers to a terminal magnetic micro-chamber adjacent to the central collision region; and coordinating valve-open phases of terminal magnetic micro-chambers of a plurality of the plasma acceleration channels so that collimated plasma jets from the terminal magnetic micro-chambers converge within a localized interaction volume in the central collision region and produce fusion reactions. The energizing, reconfiguring, expelling, repeating, and coordinating steps in each operating cycle are executed according to pre-defined time-dependent control sequences without relying on intra-cycle measurement of plasma temperature, plasma density, or plasma position within the magnetic micro-chambers or the central collision region.

In embodiments of the method of the second aspect of the application, coordinating the valve-open phases may comprise timing the valve-open phases such that peak intensities of the collimated plasma jets from different plasma acceleration channels overlap in the localized interaction volume within a temporal window between about 1 nanosecond and about 1 microsecond.

In additional or alternative embodiments of the method of the second aspect of the application, repeating the confinement and expelling steps may comprise operating at least some of the magnetic micro-chambers in a pipelined manner such that, during a given portion of the operating cycle, different plasma packets occupy different magnetic micro-chambers along a plasma acceleration channel.

In further additional or alternative embodiments of the method of the second aspect of the present application, the method may further comprise, between operating cycles: receiving diagnostic data from external sensors including at least one of magnetic field sensors, driver current sensors, and fusion output detectors; and adjusting one or more of the pre-defined time-dependent control sequences for subsequent operating cycles based at least in part on the diagnostic data, while maintaining open-loop execution with respect to plasma state during each operating cycle.

In various embodiments of the method of the second aspect of the application, the method may further comprise repeating the operating cycle at a repetition rate of at least about 1 operating cycle per second; and determining net fusion energy output based on aggregate fusion energy produced over a plurality of the repeated operating cycles and aggregate energy input over the plurality of operating cycles, such that net positive energy output is obtained notwithstanding variability in fusion yield among individual operating cycles.

In accordance with a third aspect of the application, a magnetic plasma transfer system is provided, comprising: a first magnetic confinement region and a second magnetic confinement region arranged in series along a plasma path; a coil array configured, when energized in a confinement mode, to generate closed or quasi-closed magnetic flux surfaces that confine plasma substantially within the first magnetic confinement region and substantially prevent plasma flow into the second magnetic confinement region along the plasma path; and a control system configured to transiently modify currents in selected coils of the coil array to enter a valve-open mode in which a localized open-flux channel is formed between the first magnetic confinement region and the second magnetic confinement region, while closed or quasi-closed magnetic flux surfaces are maintained elsewhere around at least the first magnetic confinement region. In the valve-open mode, a pressure differential between the first magnetic confinement region and the second magnetic confinement region drives plasma flow through the localized open-flux channel as a collimated plasma jet from the first magnetic confinement region into the second magnetic confinement region.

In embodiments of the system of the third aspect of the present application, the localized open-flux channel can have an effective cross-sectional area that is less than about thirty-five percent of a cross-sectional area of the first magnetic confinement region. In additional or alternative embodiments, the localized open-flux channel may comprise a time-gated weak point or breach zone in the magnetic flux surfaces, the weak point or breach zone being created by the transient modification of currents in the selected coils and removed when the currents are restored to confinement-mode values.

In accordance with a fourth aspect of the present application, a control system for a pulsed plasma device is provided, the control system comprising: a control matrix storage module configured to store one or more control matrices, each control matrix including entries that index actuators associated with the pulsed plasma device against discrete time slices within an operating cycle, each entry specifying a target value or state for a corresponding actuator at a corresponding time slice; a timing distribution network configured to generate and distribute a master clock signal to a plurality of actuator driver channels with bounded skew; a cycle execution module configured to, for each operating cycle, read entries of a selected control matrix in synchronization with the master clock signal and issue corresponding commands to the actuator driver channels such that the actuators follow pre-defined time-dependent trajectories during the operating cycle; and an adaptation module configured to receive diagnostic data from external sensors between operating cycles and to adjust one or more of the control matrices for subsequent operating cycles based at least in part on the diagnostic data. The control system is configured such that, during execution of each operating cycle, the actuator commands are not altered in response to intra-cycle measurements of plasma temperature, plasma density, or plasma position within the pulsed plasma device.

In embodiments of the control system, the actuators may comprise at least one of base coils, driver coils, trim coils, and valve abstractions associated with magnetic micro-chambers of a staged plasma device, and wherein at least some entries of the control matrices encode transitions between confinement modes and valve-open modes of the magnetic micro-chambers.

In additional or alternative embodiments of the control system, the timing distribution network is configured to provide synchronization accuracy between actuator driver channels on the order of sub-nanosecond intervals across at least a portion of the operating cycle; and a temporal resolution of the control matrices and the master clock enables specification of actuator command timing with picosecond-scale granularity, and entries of the control matrices encode time-advanced drive commands that compensate for measured or modeled response times of coils and driver hardware so that effective magnetic topology changes at specified spatial locations occur within targeted convergence windows.

In further additional or alternative embodiments of the control system, the adaptation module can be configured to compute or update the control matrices by convolving desired effective magnetic field trajectories with inverse or approximate-inverse models of actuator dynamics, thereby producing time-advanced drive commands that compensate for finite rise times, delays, and ringing in actuator hardware.

In accordance with a fifth aspect of the present application, a plasma energy recovery system is provided comprising: a magnetic micro-chamber configured to confine plasma within quasi-closed magnetic flux surfaces during a confinement phase; a magnetic field system comprising a plurality of coils arranged with respect to the magnetic micro-chamber and configured, when energized in an exhaust phase, to form a transient open-flux channel between an interior of the magnetic micro-chamber and an exhaust region; an engineered field weak point adjacent to the transient open-flux channel, the engineered field weak point being configured to promote plasma detachment from the quasi-closed magnetic flux surfaces and outflow into the exhaust region when the exhaust phase begins; and an energy recovery structure coupled to the exhaust region and configured to receive plasma and fusion products directed through the transient open-flux channel as a time-gated plasma jet. The transient open-flux channel is formed by coordinated changes in currents in selected coils of the magnetic field system that reconfigure a portion of the magnetic flux surfaces at a boundary of the magnetic micro-chamber from the confinement phase to an exhaust valve-open phase.

In embodiments of the plasma energy recovery system of the fifth aspect of the application, the energy recovery structure may comprise at least one of a thermal heat exchanger, an electrostatic direct energy converter, and an inductive energy converter.

The plasma energy recovery system may be implemented in combination with a fusion energy system comprising a plurality of plasma acceleration channels and a central collision region, wherein the coordinated changes in currents in the selected coils use the same magnetic topology reconfiguration mechanism that forms transient open-flux channels between adjacent magnetic micro-chambers in the fusion energy system.

Additional aspects, embodiments, and variations will be apparent from the detailed description, drawings, and claims that follow.

### BRIEF DESCRIPTION OF THE DRAWINGS

FIG. 1 is a schematic top-level view of a fusion energy system according to the application, showing multiple plasma acceleration channels arranged around and directed toward a central collision region;

FIG. 2 is a cross-sectional view of a representative plasma acceleration channel, illustrating a sequence of magnetic micro-chambers, associated coils, and the locations of magnetic micro-valves between chambers;

FIG. 3 is a block diagram of a representative plasma path, showing the flow of plasma from an injector through staged micro-chambers to the central collision region and onward to one or more exhaust regions coupled to energy-handling subsystems;

FIG. 4A is a schematic illustration of a single micro-chamber operating in a confinement mode (Mode 1), showing coil positions and exemplary closed magnetic flux surfaces that define the chamber volume;

FIG. 4B is a schematic illustration of the micro-chamber of FIG. 4A operating in a valve-open mode (Mode 2), showing a localized reconfiguration of magnetic topology and a transient open-flux channel forming a jet path into an adjacent region;

FIG. 5 is a timing diagram showing exemplary driver and trim coil current waveforms during a transition between confinement mode and valve-open mode for two adjacent micro-chambers;

FIG. 6 is a detailed view of a valve throat region, illustrating representative magnetic field lines and the geometry of a collimated plasma jet passing through the open-flux channel;

FIG. 7 is a sequence diagram illustrating staged plasma transfer through multiple micro-chambers in a single channel, from initial injection to arrival in a terminal micro-chamber;

FIG. 8 is a schematic representation of the central collision region, showing converging plasma jet paths from multiple channels and the geometry of the microscale interaction zone;

FIG. 9 is a timing diagram illustrating synchronization of terminal valve-open events across several channels so that final plasma jets arrive at the collision region within a defined temporal window;

FIG. 10 is a detailed view of the collision region during a convergent event, showing overlapping jets and the formation of a transient high-density plasma volume;

FIG. 11 is a block diagram of a control system architecture suitable for implementing matrix-based control of the coil system and valve states, including control matrix storage, timing distribution, and driver interfaces;

FIG. 12 is a schematic representation of a control matrix structure, showing the mapping of coil indices and time slices to commanded current values and valve states within an operating cycle;

FIG. 13 is a block diagram of a timing distribution network, illustrating a master clock source, phase-locked clock distribution, and synchronized coil driver channels;

FIG. 14 is a flowchart of a representative cycle-to-cycle learning process, showing acquisition of external measurements, evaluation of performance metrics, and update of control matrices for subsequent cycles;

FIG. 15 is a schematic view of representative exhaust valve locations relative to selected micro-chambers and the central collision region, illustrating the routing of plasma into exhaust regions;

FIG. 16 is a block diagram of exemplary energy-handling pathways coupled to the exhaust regions, including thermal heat-exchange systems and optional direct energy conversion subsystems;

FIG. 17 is a detailed view of an engineered field weak point or instability zone used during an exhaust phase to enhance plasma jet formation into an exhaust region;

FIG. 18 is a schematic cross-section of a representative three-tier coil arrangement for a plasma channel, showing base field coils, driver coils, and trim coils associated with one or more micro-chambers;

FIG. 19 is a cross-sectional view illustrating an oversized guide structure surrounding a plasma channel, showing the relationship between plasma cross-section, coil apertures, and mechanical supports;

FIG. 20 is a schematic representation of an array of modular fusion units according to the present application, showing multiple units coupled to a common electrical bus or power distribution system; and

FIG. 21 is an illustrative timing budget diagram, showing example time scales for coil transitions, valve-open durations, plasma transit between chambers, and overall operating cycle repetition rate.

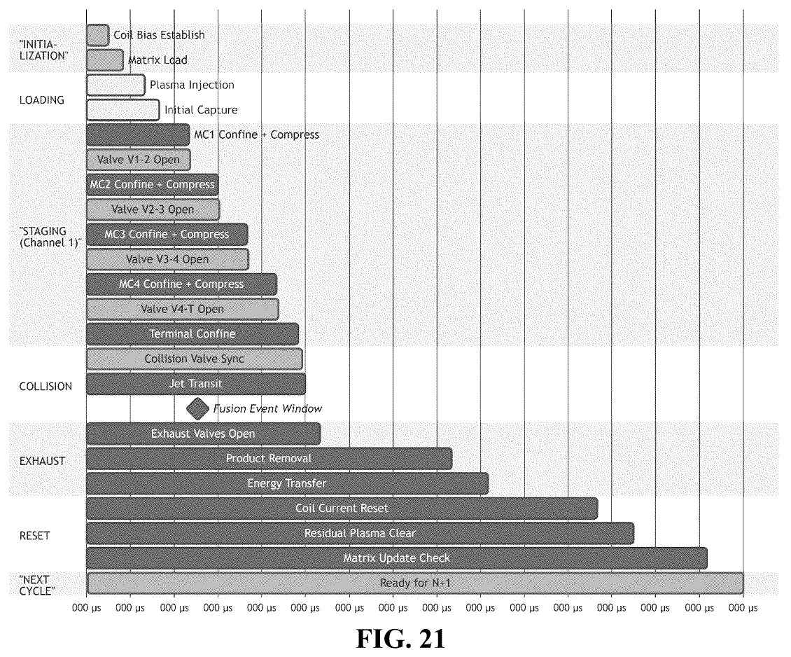

The drawings are schematic in nature and are not necessarily to scale. Certain dimensions may be exaggerated for purposes of illustration, and similar reference numerals in different figures may denote similar or corresponding elements for convenience of description.

### DETAILED DESCRIPTION OF THE DRAWINGS

### 1.1 System Overview and Design Philosophy

### 1.1.1 Statistical Fusion Concept

The present application provides a fusion energy generation system, referred to herein as a “statistical fusion engine,” that operates by executing a large number of rapid operating cycles, each involving localized plasma collision events in a small central region. Rather than maintaining a single large plasma in a stable, long-lived configuration or achieving extremely high gain in a small number of discrete events, the system is designed to produce variable per-cycle fusion yield and achieve net positive energy output through accumulation over many cycles.

In representative embodiments, per-cycle fusion success rates may be less than ten percent and in some cases less than one percent, and in some designs even less than about 0.1 percent or 0.01 percent, provided that aggregate fusion energy output over many cycles exceeds aggregate input energy. Rather than treating per-cycle variability as a problem to be eliminated, the application accommodates such variability while focusing on aggregate energy gain over many cycles.

This approach contrasts with traditional magnetic confinement devices, such as tokamaks or stellarators, which seek to maintain a stable plasma state for extended periods through continuous real-time feedback control, and with inertial confinement systems, which seek to maximize the yield of each individual compression event. The statistical fusion engine instead derives its performance from the repetition of many transient, localized collision events, leveraging a staged micro-chamber and magnetic valve architecture that permits high repetition rates without requiring real-time plasma state feedback during each cycle.

### 1.1.2 High-Level Architecture

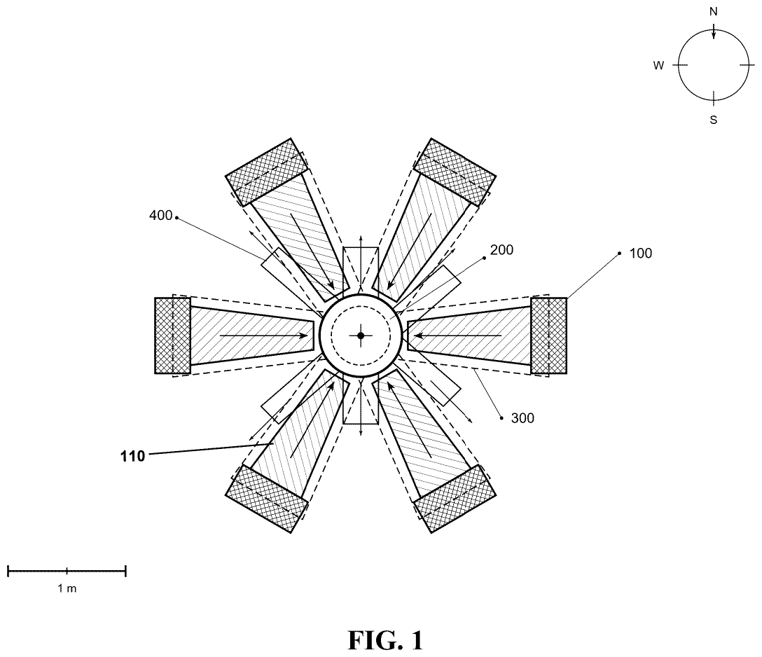

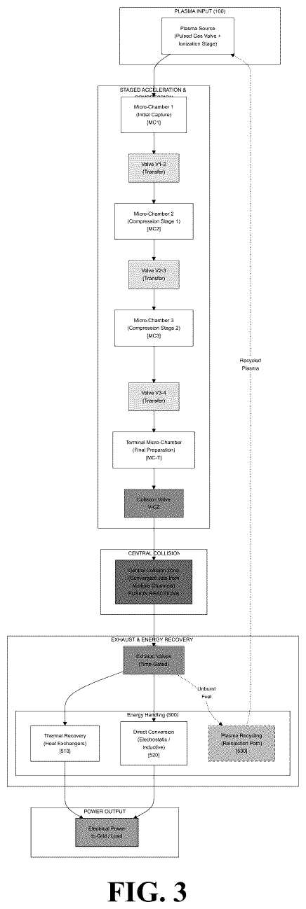

A representative embodiment of the fusion energy system includes a plurality of plasma sources 100, a plurality of plasma acceleration channels 110, a central collision region 200, a distributed magnetic field system including base coils 300, driver coils 310, and trim coils 320, a digital control system 600-650, and one or more exhaust regions 400 coupled to energy-handling subsystems 500. FIG. 1 provides a schematic top-level view of the system, showing multiple plasma acceleration channels 110 arranged around and directed toward the central collision region 200. FIG. 3 provides a block diagram of the plasma path from injector through stages to collision to recovery.

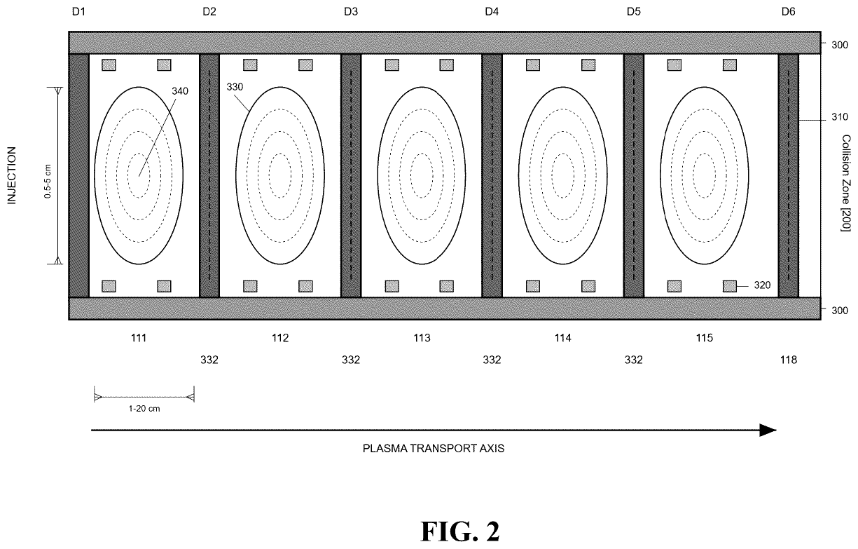

Each plasma acceleration channel 110 comprises a series of magnetic micro-chambers 111 to 116. arranged along a plasma transport axis, as illustrated in the cross-sectional view of FIG. 2. Between adjacent micro-chambers, the magnetic field system is configured to act as a magnetic micro-valve 330: in a first mode (confinement mode or Mode 1), the field topology presents substantially closed flux surfaces 340 that confine plasma within each chamber; in a second mode (valve-open mode or Mode 2), a localized portion of the topology is transiently reconfigured to form a narrow open-flux channel 440 through which plasma can be transferred as a collimated jet 444.

Multiple channels 110 terminate at or near the central collision region 200. Terminal micro-chambers 117 in these channels are magnetically coupled to the collision region 200 via collision valves 118, which operate on the same principle as inter-chamber valves 330. The control system 600-650 coordinates the timing of terminal valve openings across channels so that collimated plasma jets 444 from multiple directions converge in the collision region 200 within a defined temporal window.

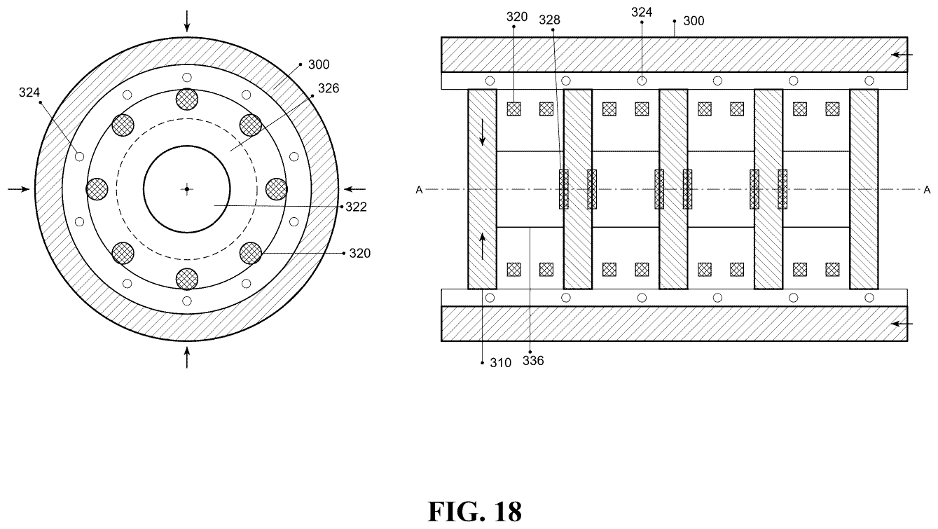

The magnetic field system includes a plurality of coils organized into functional groups: base coils 300 that provide background guiding fields along the channels, driver coils 310 (D1-D6) that create the field gradients defining micro-chamber boundaries and control valve opening and closing, and trim coils 320 that provide localized field adjustments for fine shaping of flux surfaces and valve throats. FIG. 18 illustrates a representative three-tier coil arrangement corresponding to the base coils 300, driver coils 310, and trim coils 320.

The control system includes control matrix storage 600, a cycle execution module 610, a timing distribution network 620, and coil driver interfaces 630 for base coils 300, driver coils 310, and trim coils 320. External sensors 640 supply diagnostic data to an adaptation module 650. The control system determines the time-dependent currents and valve states for all coils and adapts these parameters over many cycles based on external measurements, as further described in Section 1.7.

Exhaust regions 400 are magnetically coupled to selected micro-chambers and to the collision region 200 via exhaust-type valves 334. Plasma and fusion products are directed into these exhaust regions 400 and associated energy-handling subsystems 500 for energy extraction, thermal management, and optional routing through recycling paths 530 to upstream stages. FIG. illustrates representative exhaust valve locations.

1.1.3 Distinction from Prior Approaches

Conventional magnetic confinement systems are designed to establish and maintain a single large plasma volume in global equilibrium, using continuous real-time feedback to suppress instabilities over extended time scales. In contrast, the present application decomposes the plasma path into a sequence of small, localized micro-chambers, each of which confines a discrete plasma packet only briefly during a particular phase of the operating cycle.

Unlike prior colliding plasma or colliding beam systems, which typically use few stages, static magnetic topologies, or release plasma from magnetic control before collision, the present application employs dynamic micro-valves between multiple stages. Plasma remains under continuous magnetic guidance through a sequence of staged compression and transfer events, with active topology reconfiguration at each transition. This allows the system to deliver plasma packets to the collision region with controlled timing and trajectory, supporting the statistical operating regime.

Conventional feedback-based control for fusion devices typically relies on real-time plasma diagnostics and high-bandwidth feedback loops to adjust confining fields during each pulse or burn. In contrast, the present application employs pre-computed control sequences that specify coil currents and valve states as functions of time within each cycle. No intra-cycle measurement of plasma temperature, density, or position is required. External measurements taken between cycles are used to refine the control sequences over time, but each cycle proceeds according to its pre-defined matrix.

### 1.2 Plasma Channels and Micro-Chamber Architecture

### 1.2.1 Channel Geometry

The system includes a plurality of plasma acceleration channels 110 each defining an elongated plasma transport axis extending from an upstream injection region to a downstream terminal region adjacent to the central collision zone 200. In representative embodiments, as illustrated in FIG. 1, between three and twelve channels 110 are disposed around the collision region 200, with their transport axes intersecting at or near the collision zone.

The length of each channel depends on the desired number of acceleration and compression stages, the inter-chamber spacing, and the overall system scale. Representative channel lengths range from tens of centimeters to several meters. In some embodiments, all channels are substantially identical; in other embodiments, channels may differ in the number of stages, chamber geometries, or other parameters.

Channels may be arranged in a radially symmetric pattern, a quasi-symmetric pattern, or other geometries that provide suitable convergence at the collision region. The arrangement is selected to balance mechanical and magnetic design constraints, exhaust access, and collision geometry.

### 1.2.2 Micro-Chamber Definition

As used herein, a “micro-chamber” refers to a localized magnetic confinement region within a plasma channel 110, the confinement volume of which is defined primarily by closed or quasi-closed magnetic flux surfaces generated by the coil system, rather than by material walls. The surrounding guide structure 326 provides vacuum containment and mechanical support but does not directly confine the plasma; confinement is magnetic.

Each micro-chamber has a characteristic axial length along the transport axis and a characteristic transverse dimension. In representative embodiments, the axial length is on the order of about 1 centimeter to about 20 centimeters, and the transverse dimension is on the order of about 0.5 centimeters to about 5 centimeters, though these dimensions are illustrative and not limiting.

The number of micro-chambers per channel may vary. In some embodiments, each channel includes at least three micro-chambers, and in other embodiments four to twenty micro-chambers are used to provide multiple stages of acceleration and compression between the injector and the terminal region. Additional chambers may be added to increase the total number of stages, subject to practical constraints on channel length, timing, and control complexity.

Each micro-chamber functions as a temporary containment and pressure reservoir during a portion of the operating cycle. Plasma packets are introduced into a chamber, confined for a dwell period during which they may be compressed or conditioned, and then transferred to an adjacent region via a valve event. Different micro-chambers along a channel may be in different phases of this cycle at any given time, enabling pipelined operation in which multiple plasma packets occupy different chambers simultaneously.

### 1.2.3 Micro-Chamber Field Structure

The magnetic field configuration within and around each micro-chamber is generated by a subset of the base coils 300, driver coils 310, and trim coils 320 associated with that portion of the channel 110.

Base coils 300, typically solenoidal windings surrounding the channel 110, provide a background guiding magnetic field substantially aligned with the transport axis. This guiding field provides radial confinement and establishes the overall magnetic geometry. Base coil currents may be held steady or varied slowly compared to the operating cycle.

Driver coils 310 are located near the axial boundaries between adjacent micro-chambers. When appropriately energized, driver coils 310 create field gradients that define the axial extent of each chamber, establishing mirror-like conditions at the chamber ends. By adjusting driver coil currents, the system can compress or expand the plasma within a chamber and can open or close the magnetic micro-valve 330 at a chamber boundary.

Trim coils 320 are distributed around the periphery of each micro-chamber and near the inter-chamber boundaries. Trim coils 320 generate localized field perturbations that allow fine adjustment of flux surface shape and position. Trim coils 320 play a key role in shaping the valve throat 328 during valve-open events and in compensating for mechanical or manufacturing asymmetries.

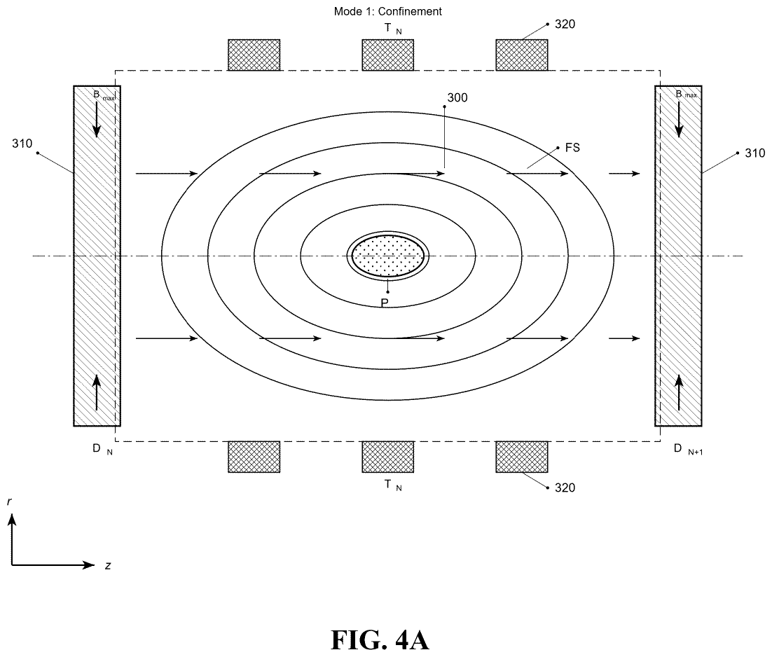

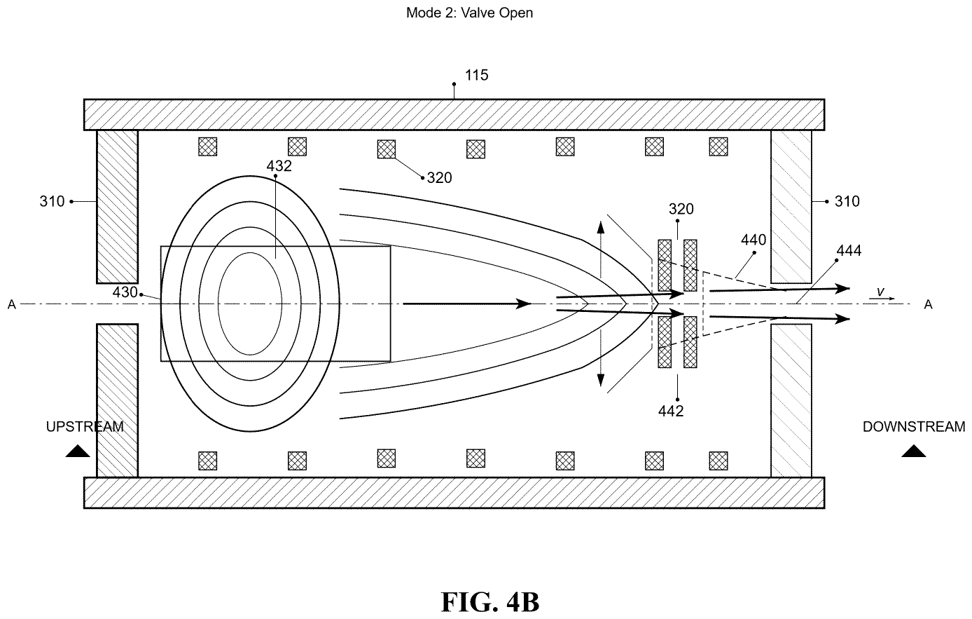

In the confinement mode (Mode 1), the combined action of base coils 300 (B), driver coils 310 (D_{N}, D_{N+1}), and trim coils 320 (T_{N}) produces closed or quasi-closed flux surfaces that substantially surround the plasma packet and prevent its escape along the axis or radially. FIG. 4A illustrates a micro-chamber in Mode 1, with nested closed flux surfaces (FS) confining the plasma (P). In the valve-open mode (Mode 2), coordinated changes in driver and trim coil currents locally alter the magnetic topology at a chamber boundary, creating a transient connection to an adjacent region while flux surfaces elsewhere remain closed or quasi-closed. FIG. 4B illustrates a micro-chamber in Mode 2, with a narrow open-flux channel 440 formed at the downstream boundary. The detailed behavior of the valve is described in Section 1.3.

### 1.3 Magnetic Micro-Valve Mechanism and Jet Transfer

### 1.3.1 Operational Modes

As described above, each micro-chamber boundary can operate in one of two modes. In the confinement mode (Mode 1), closed or quasi-closed magnetic flux surfaces 430 surround the plasma region 432, inhibiting axial and radial escape. The chamber functions as a magnetic pressure vessel, with the plasma confined at elevated pressure relative to adjacent regions.

In the valve-open mode (Mode 2), currents in selected driver coils 310 and trim coils 320 are transiently modified to reconfigure the magnetic topology at the boundary. A narrow open-flux channel 440 is created that connects the interior of the upstream chamber to the interior of the downstream chamber or to the collision region 200. Flux surfaces 430 elsewhere in the chamber remain closed or quasi-closed, so that the plasma packet is expelled preferentially through the open channel 440 in a collimated plasma jet 444.

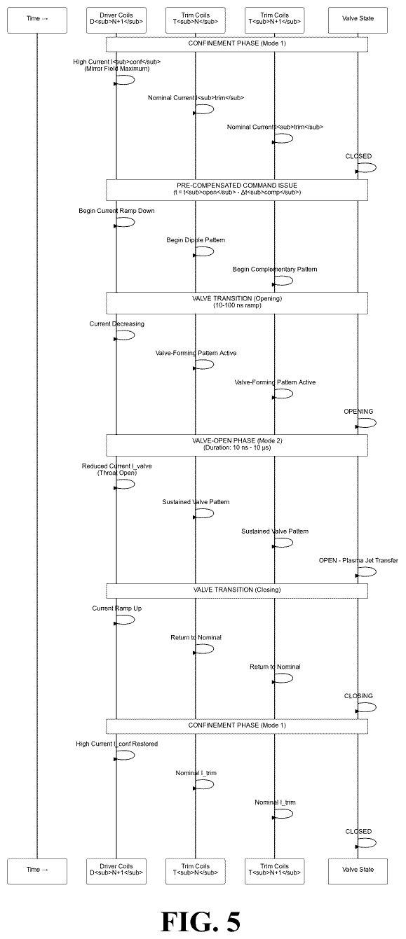

The transition between modes is effected by coordinated, time-synchronized changes in driver and trim coil currents, as illustrated in FIG. 5. The valve-open duration is typically much shorter than the confinement dwell time in each chamber.

### 1.3.2 Topology Reconfiguration and Valve Throat

In the confinement mode, the downstream boundary of a given micro-chamber (chamber N) is defined by a field maximum generated by the downstream driver coil 310 (associated with chamber N+1). This field maximum acts as a magnetic mirror, reflecting particles attempting to escape along the axis.

To create a valve, a transient change is applied to the downstream driver coil 310 and to trim coils 320 near the boundary. In representative embodiments, the driver coil current is reduced or reversed, lowering the mirror field strength, while trim coils 320 are driven in a pattern that creates a localized distortion of the flux surfaces.

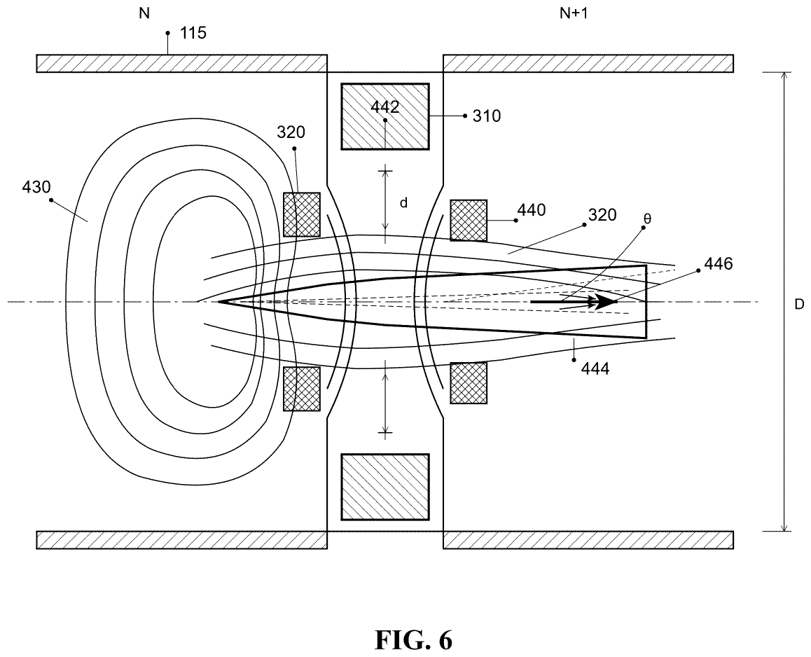

The net effect is to deform a portion of the previously closed flux surfaces such that a slender bundle of field lines forms a continuous path from the interior of chamber N to the interior of chamber N+1. This can be visualized as a “needle-prick” in the otherwise closed magnetic surface: the majority of the confinement structure remains intact, but at a specific location and for a limited time, plasma can escape along a narrow, magnetically guided path through a valve throat 442 and associated open-flux channel 440. FIG. 4A shows closed surfaces in confinement mode; FIG. 4B shows the valve throat 442 open; FIG. 6 provides a detailed view of the valve throat 442 region. In FIG. 6, the valve throat has a diameter (d), and the collimated plasma jet 444 has a velocity vector 446 and half-angle (θ) less than 10°.

In some embodiments, the localized deformation that forms the valve throat 442 can be understood as an engineered, time-gated weak point or breach zone in the confining magnetic field, conceptually similar to controlled field instabilities described elsewhere herein. In other embodiments, the throat is obtained without deliberately creating a region of reduced overall stability, but rather by locally reconnecting or re-routing selected flux surfaces while keeping the remainder of the chamber fields stable. In both cases, the effect is to create a transient, spatially localized magnetic opening that enables plasma transfer along a controlled path between confinement regions.

When driver and trim currents are restored to their confinement-mode values, the flux surfaces revert to a closed configuration, and the valve closes. The valve throat can thus be opened and closed on time scales determined by the coil and driver response times.

The spatial extent and cross-section of the valve throat 442 are determined by the relative amplitudes and phases of the involved coil currents. In some embodiments, the effective area of the open-flux channel is substantially smaller than the cross-sectional area of the micro-chamber, for example on the order of a few percent to a few tens of percent (typically less than about thirty-five percent), so that the plasma is expelled as a relatively narrow, directed jet 444 rather than as a diffuse flow.

### 1.3.3 Jet Formation

When plasma is loaded and compressed in a micro-chamber, it attains a higher pressure than the downstream region. Upon valve opening, the pressure differential drives plasma through the open-flux channel. Because the channel is narrow and magnetically guided, the escaping plasma forms a jet 444 directed along the field lines into the downstream region.

The jet velocity 446 depends on the upstream plasma conditions, the field gradients at the throat 442, and any additional accelerating fields. The directed velocity component along the axis is substantially greater than the bulk thermal velocity of the plasma before the valve opens. The transverse spread of the jet is constrained by the magnetic geometry of the throat, so the jet remains collimated over the inter-chamber distance.

In representative embodiments, the valve-open duration may be on the order of tens of nanoseconds to several microseconds, for example about 10 ns to 10 μs, and the resulting jet velocities may be on the order of tens to hundreds or thousands of kilometers per second, for example at least about 10 km/s and in some embodiments between about 10 km/s and about 1,000 km/s, including representative ranges on the order of about 30 km/s to about 50 km/s as in earlier designs, depending on stage parameters. The fraction of plasma transferred in a single valve event can be controlled by adjusting the valve-open duration, the effective throat area, and the pressure difference between chambers. The remaining plasma, if any, can either be retained for additional processing or removed through separate exhaust operations.

In some embodiments, approximate jet velocities can be estimated by relating the upstream plasma pressure to the plasma mass density, for example using:

$${v}_{j} \approx \sqrt{\frac{2 Δ P}{ρ}}$$

where vⱼ is the jet speed along the axis, ΔP is the effective pressure difference between the upstream micro-chamber and the downstream region at the onset of valve opening, and p is the mass density of the plasma. Such relations and more detailed magnetohydrodynamic models are well known to those of ordinary skill in the art and may be used to select staging pressures, valve throat geometries, and valve-open durations consistent with desired jet velocities and energy transfer.

### 1.3.4 Sequential Staging

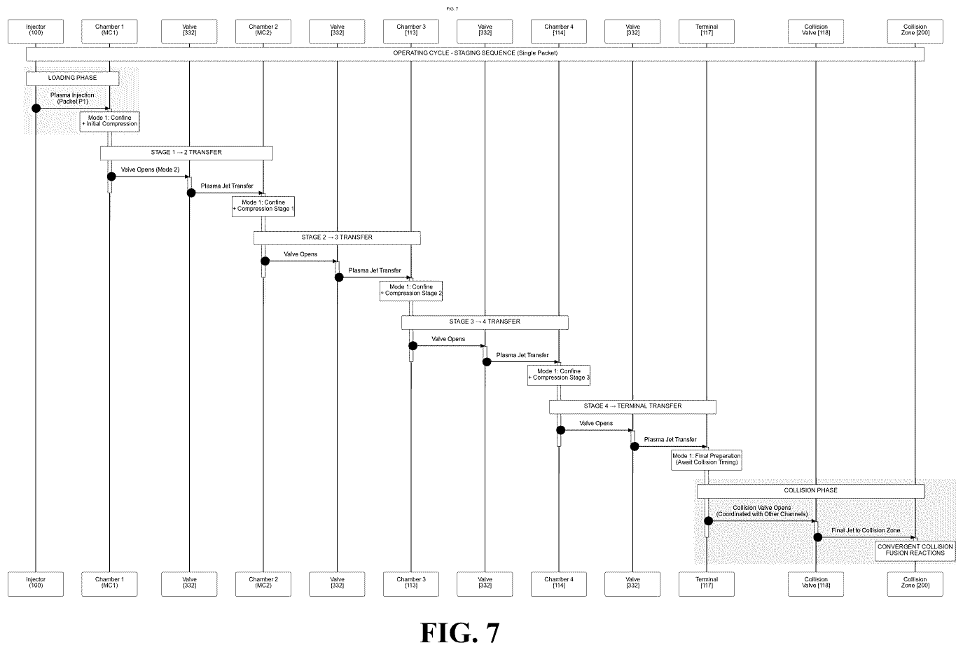

By repeating the confinement and valve-open sequence across successive pairs of micro-chambers, plasma packets are advanced through the channel in a staged manner, as illustrated in FIG. 7. A packet is injected into the first (most upstream) micro-chamber (MC1), confined and conditioned, then transferred via the first valve to the second chamber (MC2), where it may be further compressed, then transferred to the third chamber, and so on until it reaches the terminal micro-chamber 117 near the collision region 200.

At each stage, the plasma packet may experience increases in pressure, density, kinetic energy, or ionization state. The staging ratios and timing at each stage are adjustable by system design and by the control matrices. In some embodiments, operation is pipelined: multiple plasma packets occupy different micro-chambers along the channel at different phases of the staging sequence.

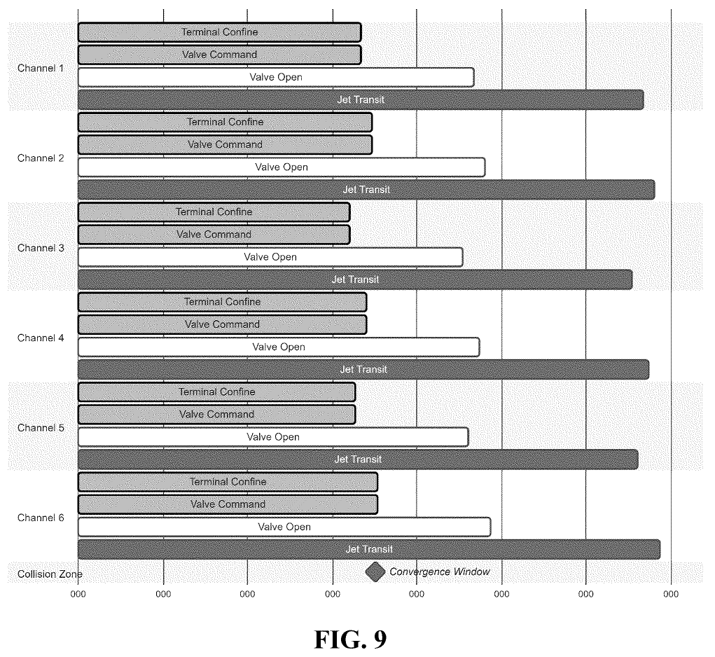

The coordinated operation of inter-chamber valves regulates where the plasma is at any given time and controls when it reaches the collision region. As illustrated in FIG. 9, the timing is designed so that plasma packets in different channels, which may be at different stage numbers and have different path lengths, are delivered to their respective terminal micro-chambers in synchrony, and the final jets converge in the collision region within a specified temporal window.

### 1.3.5 Valve Functional Classes

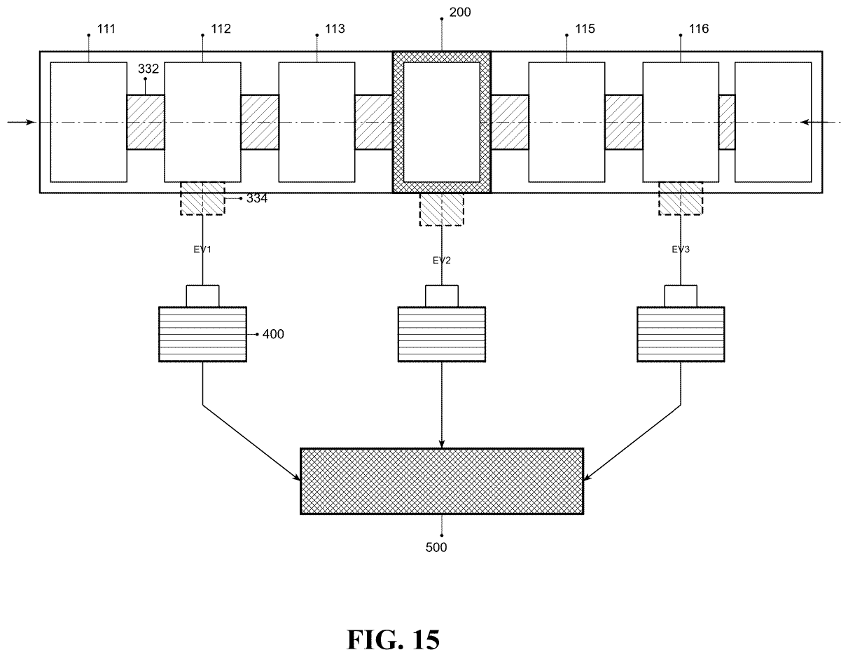

Not all valves in the system direct plasma along the main acceleration path. As illustrated in FIG. 15, two functional classes of valves may be distinguished:

Transfer valves 332 create an open-flux channel 440 that connects an upstream micro-chamber to a downstream micro-chamber along the channel axis. When a transfer valve 332 opens, the resulting jet is directed toward further staging and ultimately toward the collision region 200.

Exhaust valves 334 create an open-flux channel 440 that connects a micro-chamber or the collision region 200 to an exhaust region 400 that is not part of the main staging path. Exhaust valves 334 are used to remove residual plasma, fusion products, or impurities from the system after collision events or to relieve pressure in selected chambers. FIG. 15 shows a schematic of exhaust valve locations.

The underlying magnetic mechanism is the same for both valve types: a transient reconfiguration of driver coils 310 and trim coils 320 creates a narrow open-flux channel 440 through which plasma is expelled as a jet. The difference lies in the destination and the timing of actuation.

Exhaust valve regions may include additional field shaping or structural features to facilitate coupling to energy-handling subsystems 500 and recycling paths 530. The design of such downstream equipment follows established engineering practice and is not essential to the definition of the valve mechanism.

1.3.6 Distinction from Prior Art

Unlike static magnetic configurations such as tokamak divertors, mirror loss cones, or magnetic cusps, the micro-valve topology is dynamically reconfigured within each operating cycle under digital control. The same coils that produce closed flux surfaces during one phase of the cycle produce an open channel during another phase. Transitions occur on nanosecond to microsecond time scales.

Unlike continuous plasma flow through permanently open field lines, the present application provides discrete transfer events. Each valve opening is a bounded event with a defined start, duration, and end, which enables statistical operation with definite cycle boundaries.

Unlike single-stage compression or colliding-beam devices that release plasma from magnetic control before collision, the staged architecture of the present application maintains magnetic guidance throughout the acceleration and compression sequence. Plasma remains confined in magnetically defined structures until it is deliberately released through a valve.

The collimated jet produced by the narrow valve throat differs from bulk plasma transfer through large apertures. The jet carries substantial directed momentum, remains coherent over the inter-chamber distance, and supports the formation of a convergent wavefront at the collision zone.

### 1.4 Coil and Driver Hardware

### 1.4.1 Coil Types

The magnetic field system comprises a distributed arrangement of coils for a plasma channel 322 organized into three functional tiers of coils 300, 310, 320, as illustrated in FIG. 18:
(a) Base coils 300 provide relatively uniform guiding magnetic fields along the plasma channels 110. Base coils 300 are typically solenoidal windings surrounding the channel structure and operate in a quasi-steady manner with slow current changes relative to the operating cycle time scale. Base coils 300 establish the overall magnetic geometry and provide background radial confinement.
(b) Driver coils 310 are located at the boundaries between adjacent micro-chambers and at the interface between terminal chambers and the collision region 200. Driver coils 310 are capable of rapid current changes and produce stronger, localized field gradients. Driver coils 310 are responsible for the compression pulses within chambers and for the opening and closing of micro-valves 330.
(c) Trim coils 320, which in some embodiments may be implemented as precision array coils or coil arrays as described in earlier designs, are located near the periphery of each micro-chamber 336 and near the valve throat regions. Trim coils 320 generate localized field perturbations that allow fine adjustment of flux surface shape and symmetry. During valve events, trim coils 320 shape the valve throat 328 geometry and control the collimation of the jet.

Coils 300, 310, 320 may be wound on or embedded in structural supports that also form part of the vacuum boundary. Coil apertures and structures are dimensioned larger than the plasma cross-section to allow for fabrication tolerances, cooling channels 324, and diagnostic access. Specific winding geometries may vary; the requirement is that the combined fields from all coils in a region produce the desired magnetic topologies.

### 1.4.2 Coil-to-Chamber Assignment

The coils are grouped and assigned to specific micro-chambers and boundaries in a manner that facilitates control abstraction.

Each micro-chamber N is associated with: (a) a segment of base coil 300 providing the background guiding field over the chamber volume; (b) an upstream driver coil 310 at the boundary between chambers N−1 and N, and a downstream driver coil at the boundary between chambers N and N+1, which together define the mirror-like axial boundaries of chamber N; and (c) a set of trim coils 320 (T_{N}) distributed around the chamber N periphery and near the valve regions.

The valve between chambers N and N+1 is formed primarily by coordinated changes in the downstream driver coil (at the N/N+1 boundary) and trim coils T_{N} and T_{N}+1 near that boundary. When these coils are driven in the valve-forming pattern, the magnetic topology opens; when they return to confinement-mode currents, the valve closes.

This coil-to-chamber mapping is reflected in the control data structures: control matrices may index chambers and boundaries rather than individual physical coil identifiers, allowing high-level reasoning about valve and chamber operations while the control system translates these into low-level coil commands.

### 1.4.3 Driver Electronics

Driver electronics convert digital commands from the control system 600-650 into controlled current waveforms delivered to individual coils 300, 310, 320 or coil groups.

A bulk power source, such as a DC bus or low-frequency AC supply, provides energy to local power stages associated with each coil or set of coils. Each power stage may include an H-bridge or half-bridge circuit with solid-state switches (such as IGBTs or power MOSFETs), local energy storage elements (capacitors, inductors), and current measurement devices.

The requirements for driver stages differ by coil class. Base coil drivers prioritize efficiency and current stability over slew rate. Driver coil stages must support rapid current changes consistent with valve-open intervals. Trim coil drivers typically handle lower currents but require higher bandwidth for precise waveform shaping during transitions.

Each driver stage receives digital signals specifying target currents or switching states as a function of time. These signals are derived from the control matrices and synchronized to the master clock. Current feedback within each stage may be used to verify that commanded waveforms are achieved within tolerances, but the overall plasma behavior remains open-loop on the cycle time scale.

### 1.4.4 Timing Distribution

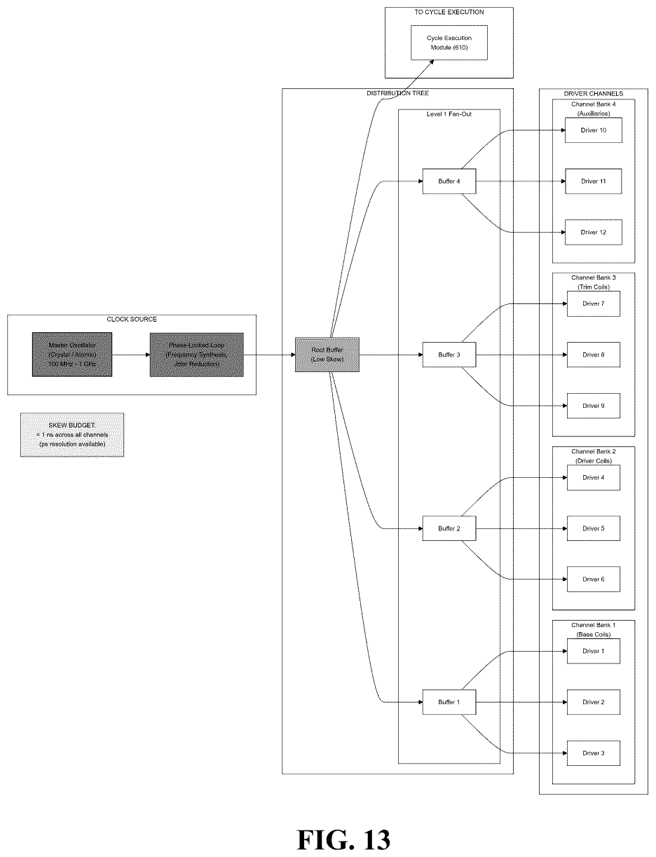

To coordinate valve-open events and other rapid field changes across multiple coils and channels, the driver electronics share a common timing reference, as illustrated in the block diagram of FIG. 13. A timing distribution subsystem provides a master clock signal to all relevant driver and control components. This may be implemented using one or more oscillators and clock distribution circuits, such as phase-locked loops and clock fan-out buffers, to deliver synchronized timing edges with low skew.

The temporal resolution of the control system is chosen such that the relative timing of commanded changes in different actuators can be controlled within a small fraction of the desired valve-open duration and plasma transit times between chambers. In representative implementations, valve-open events and current ramps occur over nanosecond to microsecond time scales, while the master clock and distribution network may provide sub-nanosecond, and in some embodiments picosecond-scale, timing resolution. This allows the control system to schedule coil drive changes in advance of desired effective magnetic field changes, compensating for known coil and driver response times while still aligning the resulting magnetic topology transitions to tight timing windows at locations of interest, such as the central collision region.

Digital control logic, such as FPGAs or real-time processors, uses the master clock to sequence control matrix entries and issue commands to driver stages. The coordinated timing underpins the repeatability of valve and staging operations across many cycles. Some embodiments stream matrix data to drivers in real time; others pre-load short matrix segments into local buffers within the driver stages to reduce communication latency.

### 1.4.5 Thermal and Mechanical Considerations

Repeated pulsing at a high repetition rate generates heat in the coils 300, 310, 320 and driver electronics. Coil formers and structural supports include cooling channels 324 through which liquid or gas coolant circulates. The oversized guide structures 326 and coil apertures (Section 1.4.6) provide space for coolant flow and thermal insulation.

Mechanical supports are designed to withstand electromagnetic forces arising from rapid current changes, including forces between adjacent coils 300, 310, 320 and between coils and conductive structures. Materials and mounting arrangements accommodate thermal expansion and contraction without degrading alignment beyond the range that can be compensated by trim coils 320.

In some embodiments, base coils 300 are superconducting and housed in cryostats, while driver coils 310 and trim coils 320 are resistive and cooled at higher temperatures. In other embodiments, all coils 300, 310, 320 are resistive, simplifying thermal and mechanical design at the cost of higher power consumption. The choice of coil technology does not alter the fundamental staged micro-chamber and valve architecture.

### 1.4.6 Oversized Guide Structures

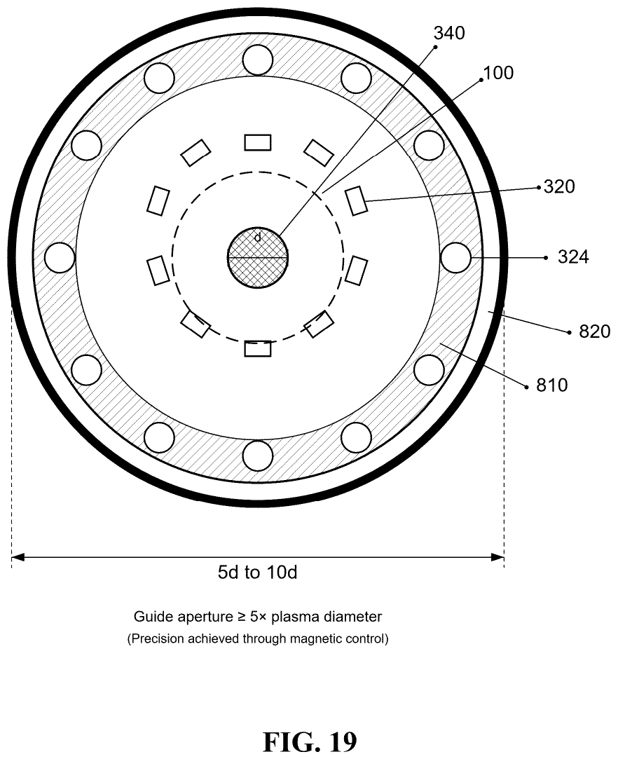

As illustrated in FIG. 19, the guide structures 326 and coil apertures are dimensioned substantially larger than the plasma cross-section. In representative embodiments, the internal aperture of the guide structure 326 is on the order of five to ten times larger than the characteristic transverse dimension of the plasma packet.

This oversized design provides several benefits. First, it relaxes manufacturing tolerances for the guide and coil former structures, permitting standard machining rather than precision fabrication. Field uniformity and confinement quality are achieved through trim coil adjustments 320 rather than mechanical precision.

Second, the additional space allows integration of cooling channels 324, diagnostic access ports, and shielding structures 810 without encroaching on the plasma volume. The wall of the guide structure 326 may be implemented as a guide structure wall 820 that integrates such features.

Third, the design reduces sensitivity to small mechanical misalignments or thermal deformations during operation. Such imperfections are compensated by matrix-controlled trim coils 320 rather than by mechanical correction.

The overall design philosophy is to achieve spatial precision through magnetic control rather than through mechanical fabrication. This approach is consistent with the statistical operating regime, in which individual cycles need not be optimal as long as aggregate performance over many cycles meets requirements.

### 1.5 Central Collision Region and Multi-Stream Convergence

### 1.5.1 Collision Zone Geometry

The plasma acceleration channels 110 terminate at a central collision region 200, which is a localized volume where jets from two or more channels intersect with sufficient spatial and temporal overlap to produce fusion-relevant conditions.

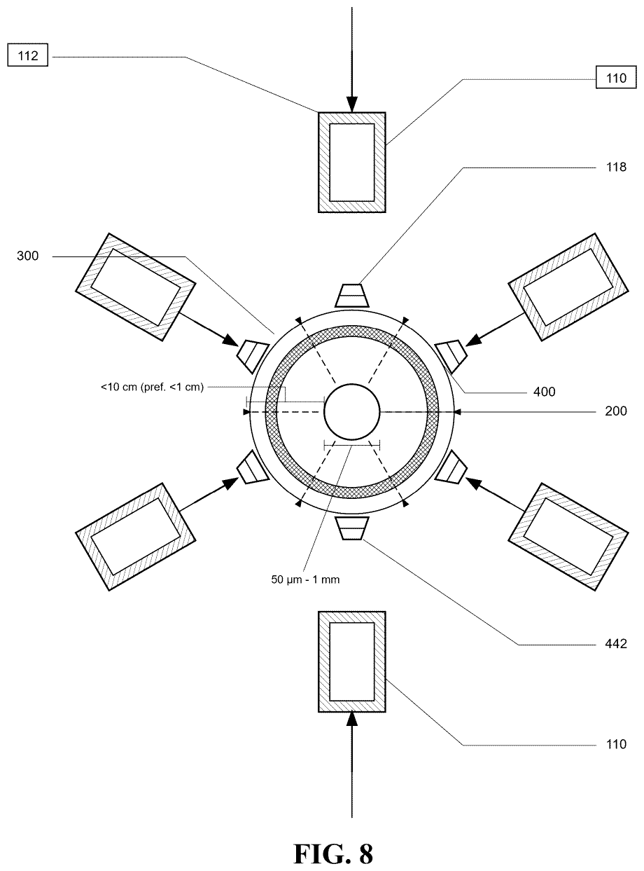

In representative embodiments, as illustrated in FIG. 8, the collision region 200 is approximately centered on the geometric symmetry axis of the channel arrangement. The geometry of the region may be spherical, ellipsoidal, or elongated, depending on the magnetic design and the number and arrangement of channels 110. A characteristic linear dimension (effective diameter) of the collision region 200 is on the order of tens of micrometers to a few millimeters, typically about 50 μm to about 1 mm.

The magnetic field configuration in the collision region 200 is generated by dedicated driver coils 310 and may include contributions from the terminal driver coils 310 and base coils 300 of the surrounding channels 110. The field may be shaped to provide a low-field interaction volume surrounded by higher-field regions that facilitate jet convergence and transient confinement, or the field may be configured to guide fusion products toward exhaust regions 400 and energy-handling subsystems 500. The specific topology is tailored to balance confinement, interaction time, and exhaust handling.

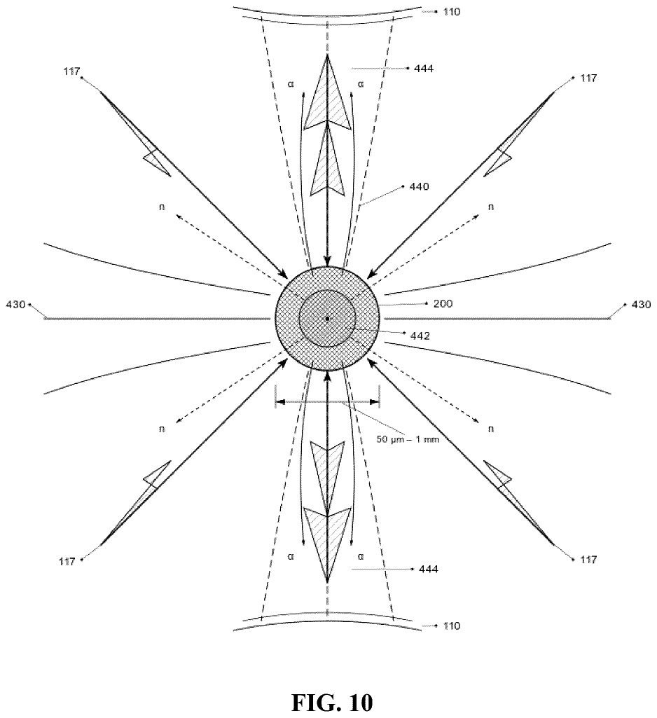

FIG. 10 illustrates a detailed view of the central collision region 200 during a convergent event. Multiple terminal micro-chambers 117 at the ends of respective plasma acceleration channels 110 are arranged around the collision region 200. Each terminal micro-chamber 117 forms a collimated plasma jet 444 through a corresponding valve throat 442 and open-flux channel 440 directed toward a localized interaction volume in the collision region 200. In the illustrated embodiment, the jets 444 from different channels intersect within a small overlap region that defines a high-density, high-temperature interaction volume. Surrounding flux surfaces 430 confine the overall collision region, while localized perturbations near each valve throat 442 shape the jet trajectories and convergence angles. The drawing schematic emphasizes the relative geometry of the jets 444, the interaction volume, and the surrounding magnetic confinement structure.

### 1.5.2 Terminal Micro-Chambers and Collision Valves

Each plasma acceleration channel 110 includes a terminal micro-chamber located adjacent to or slightly upstream of the collision region 200. The terminal chamber is the final staging point where plasma packets are prepared before launch into the collision region 200.

The interface between the terminal chamber and the collision region 200 is a specialized micro-valve, referred to as a “collision valve” 118. The collision valve 118 operates on the same principle as inter-chamber valves 332: in confinement mode, the terminal chamber is magnetically isolated from the collision region 200 by closed flux surfaces or a field barrier; in valve-open mode, coordinated driver coil 310 and trim coil 320 current changes create a narrow open-flux channel 440 connecting the terminal chamber interior to the collision region 200.

The distance from the collision valve throat 328 to the center of the collision region 200 is preferably small relative to the channel length, for example less than about 10 cm and in some embodiments less than about 1 cm. This short distance reduces jet dispersion and alignment sensitivity and allows modest collimation angles while achieving high overlap in the interaction volume.

### 1.5.3 Convergent Jet Wavefront

During the collision phase of the operating cycle, the control system 600-650 commands the collision valves 118 of multiple channels 110 to open within a defined temporal window, as illustrated in FIG. 9. Plasma packets are expelled as jets through the valves 118 and into the collision region 200. With appropriate channel geometry, chamber spacing, and valve timing, the jets arrive at the interaction volume in a convergent arrangement, forming a collision “wavefront.”

The convergence geometry may include opposing jets from channel pairs, multiple jets arranged in a ring or polyhedral pattern, or other configurations that provide substantial mutual overlap. The velocity vectors of the converging streams are oriented so that the streams exhibit significant relative velocities and interpenetration, leading to transient local density increases and effective collision energy.

The temporal width of the convergent event is determined by the valve synchronization accuracy, the jet lengths and velocities, and the residual path length differences among channels. The control system aims to align the peak jet intensities within a time window on the order of nanoseconds to microseconds, for example about 1 ns to about 1 μs. Within this window, the interaction volume experiences a brief, intense, fusion-relevant condition. After the window, the plasma expands or is directed to exhaust regions.

### 1.5.4 Representative Fusion Conditions

The exact plasma parameters at collision depend on the fuel type, staging strategy, jet velocities, and magnetic configuration. The staged system is designed to deliver plasma packets such that, at the moment of convergence, the interaction volume attains densities significantly higher than any single upstream chamber, due to the superposition of multiple jets.

In representative embodiments, the instantaneous number densities in the interaction volume may be on the order of 1022 to 1026 particles per cubic meter, effective ion temperatures may be in the keV range, and interaction times may be on the order of 10⁻⁹ to 10⁻⁶ seconds. These values are illustrative and not limiting. The transient interaction in a small volume does not require long-duration global confinement; instead, the system relies on the repeated creation of such conditions at high repetition rate.

Fusion reactions occurring during each convergent event produce neutrons, charged particles, and energetic plasma. A portion of the products remains near the collision region 200 briefly; another portion is directed to exhaust regions 400 through engineered field configurations and exhaust valves 334. The number of reactions per event varies from cycle to cycle due to statistical variations in jet parameters and alignment. The system is designed to tolerate this variability and to achieve a desired average output over many events, rather than requiring uniform yield per collision.

1.5.5 Distinction from Prior Colliding Plasma Concepts

The collision zone architecture described herein differs from prior colliding plasma concepts in several respects. Jets entering the zone have been staged through multiple micro-chambers with progressive compression. Plasma remains under magnetic guidance until the moment of collision valve opening. Jets are delivered with nanosecond-scale timing precision coordinated across channels. Prior colliding-beam or plasmoid systems typically employ fewer stages, release plasma from magnetic control before collision, or operate at substantially lower repetition rates.

### 1.6 Operating Cycle and Statistical Mode

### 1.6.1 Definition of Operating Cycle

An “operating cycle” refers to a complete sequence of actions and field configurations that is repeated over time. During each cycle, plasma is injected, staged through chambers, collided in the central region, and cleared from the system. The operating cycle may be defined for a single channel, a group of channels, or the entire multi-channel system, depending on the scheduling and interleaving strategy.

In some embodiments, a global operating cycle encompasses all channels and collision events, repeating at a rate determined by plasma transit times, valve timing, and energy-handling constraints. In other embodiments, channels operate with phase-shifted cycles so that different channels are in different phases at any given time, resulting in a quasi-continuous sequence of collision events from the perspective of the energy-handling subsystem.

### 1.6.2 Cycle Phases

A representative operating cycle includes the following phases:
(a) Initialization: Base and driver coils are energized to establish guiding fields and initial chamber topologies. Control matrices are loaded. Diagnostics verify that coil currents and vacuum conditions are within acceptable ranges.
(b) Loading: Plasma sources inject fuel into the upstream micro-chambers. Injection may be accomplished by pulsed gas valves, pulsed ionization, or other means. The upstream chambers are in confinement mode to capture and hold the injected plasma.
(c) Staging: A scheduled sequence of micro-valve events transfers plasma from upstream to downstream chambers. At each stage, the plasma may experience compression, acceleration, and conditioning. Depending on the timing strategy, valve operations in different portions of the channel may overlap.
(d) Collision: When plasma packets in terminal chambers are ready and timing across channels is aligned, the control system commands the collision valves to open according to a defined pattern. Jets from multiple channels converge in the collision region during a brief interaction window.
(e) Exhaust: After the collision event, exhaust valves in or near the collision region and in selected chambers are opened to route residual plasma and fusion products into exhaust regions. Energy is converted to a useful form by conventional energy-handling subsystems or dissipated in dumps. In some embodiments, a fraction of the plasma is routed through recycling paths for reinjection.
(f) Reset: Coil currents and valve states are returned to initial conditions for the next cycle. Any remaining plasma in staging regions is removed or neutralized. Control parameters may be updated based on measurements from the previous cycle. The system then proceeds to the next loading phase.

The durations and relative timings of these phases are adjustable to match electrical, thermal, and plasma transport characteristics of a given implementation. In general, staging and collision phases occur on microsecond or faster time scales, while exhaust and reset phases may occur on somewhat longer time scales, particularly in larger systems.

### 1.6.3 Representative Timing Budget

As an illustrative example, for a system operating at 1000 cycles per second (1 ms cycle period), the timing budget might be allocated approximately as follows: staging and collision phases occupy about 10 to 100 μs; exhaust phases occupy about 100 to 500 μs; and reset and initialization occupy the remaining time within the cycle. Control matrix time slices of about 10 to 100 ns provide sufficient resolution for valve transitions. Sensor data acquisition and matrix updates occur during reset phases at cycle boundaries.

These timing values are illustrative and may vary significantly depending on the number of stages, channel lengths, plasma conditions, and other design parameters. The control system is designed to accommodate a range of timing configurations through programmable matrices.

### 1.6.4 Cycle Repetition and Interleaving

The system is designed to operate at repetition rates significantly higher than large ICF systems and to avoid the continuous steady-state confinement complexity of tokamaks. The achievable repetition rate depends on plasma transit times, coil driver capabilities, exhaust and cooling capacities, and energy-handling constraints.

An individual channel may complete cycles at rates ranging from a few hundred to several thousand cycles per second or more. When multiple channels are operated in parallel with phase-shifted cycles, the effective collision event rate at the energy-handling interface may be substantially higher than the per-channel cycle rate.

Interleaving across channels, and in some embodiments across modules, smooths the aggregate power output and maintains nearly continuous operation from the standpoint of downstream systems. The micro-chamber and valve architecture facilitates interleaving because each channel can be controlled independently at the staging and collision timing level, subject only to synchronization constraints for shared collision events.

### 1.6.5 Statistical Regime

The operating cycle is intentionally designed to produce variable per-cycle fusion yield. Deviations in injected plasma inventory, staging efficiency, valve timing, and collision geometry naturally lead to fluctuations in the number of fusion reactions per collision event. Rather than treating such deviations as failures requiring elimination through exhaustive real-time control, the system accommodates them and focuses on achieving desired average performance over many cycles.

From an energy standpoint, the system may be characterized by an aggregate gain over a window of cycles, such as a time-averaged ratio of total fusion energy output to total input energy for plasma formation, coil operation, and auxiliary systems. Net positive operation is achieved when this aggregate gain exceeds unity, even if a significant fraction of individual cycles—for example, more than ninety percent and in some embodiments more than ninety-nine percent-produce little or no fusion output.

In the statistical regime, the role of the control system is to maintain the overall per-cycle yield distribution within acceptable bounds and to adjust staging, valve timing, and other parameters between cycles to improve the distribution over time. External diagnostics such as neutron detectors and magnetic sensors provide cycle-to-cycle feedback on aggregate behavior, while intra-cycle events proceed according to pre-computed sequences.

This approach reduces the need for complex, high-bandwidth plasma diagnostics and feedback loops. It leverages the intrinsic repeatability of the staged micro-chamber and valve architecture to deliver fusion power as the accumulated result of many rapid collision events.

### 1.7 Control System: Matrix-Based Topology Control and Learning

### 1.7.1 Control Philosophy

The control system is designed around the principle that each operating cycle is executed open loop with respect to plasma state, while aggregate behavior over many cycles is adjusted using relatively slow external feedback. Within each cycle, coil currents and valve states follow pre-computed, time-dependent trajectories that are not altered in real time in response to intra-cycle measurements of plasma temperature, density, or position.

Between cycles, the system collects diagnostic information reflecting the performance of previous cycles, such as magnetic field measurements and fusion output indicators. Based on this information, the control system may adjust control parameters for subsequent cycles. This architecture reduces the complexity and bandwidth requirements of plasma diagnostics during each cycle while still allowing adaptation over time to changes in component behavior, plasma source conditions, and operating objectives.

### 1.7.2 Control Matrix Structure

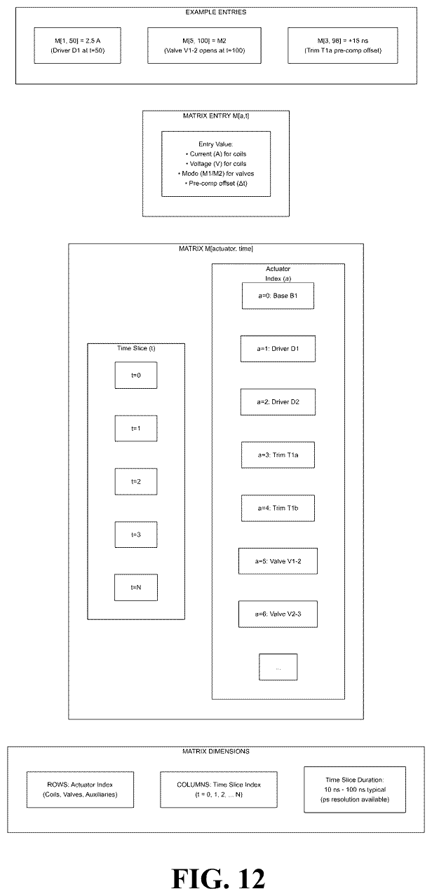

Time-dependent coil and valve commands are encoded in control matrices stored in a control matrix storage module 600, as illustrated in FIG. 12. Each control matrix is organized with one dimension indexing actuators (coils, coil groups, or valve abstractions) and another dimension indexing discrete time slices within the operating cycle.

Each matrix entry specifies a target value or state for the corresponding actuator at the given time slice. For coil actuators, entries may represent desired currents, voltages, or normalized drive levels. For valve abstractions, entries may indicate the desired mode (confinement or valve-open) and optionally parameters such as the target throat aperture or jet duration. Some implementations maintain multiple matrices for different operating modes, scale factors, or fallback patterns, with the control system selecting among them based on higher-level commands or measured conditions.

The temporal resolution of the control matrices may be selected independently of the intrinsic response times of the coils and drivers. For example, time slice durations on the order of tens of nanoseconds may be sufficient for many staging operations, while in other embodiments time slices may be as short as a few picoseconds when precise alignment of effective magnetic topology changes is desired. In such cases, the matrix entries encode pre-compensated lead and lag offsets that account for measured or modeled response dynamics of the coil and driver hardware, so that the resulting magnetic field changes at specified spatial locations occur within a targeted convergence window even though individual current ramps extend over several nanoseconds or longer.

### 1.7.3 Matrix Execution

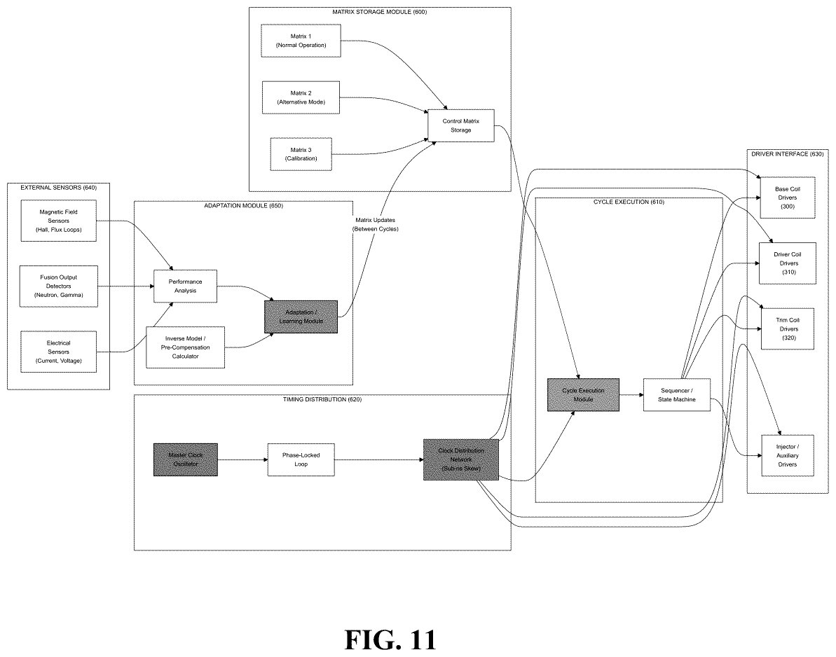

During operation, a cycle execution module 610 reads matrix entries and issues commands to driver electronics 630 in synchronization with the master clock, as illustrated in FIG. 11 and FIG. 13. At the beginning of each cycle, the execution module 610 initializes counters and pointers. At each time slice, it retrieves the entries for that slice and converts them to low-level commands for the appropriate driver channels.

The timing distribution network 620 ensures that commands are applied across all drivers with bounded skew relative to the master clock. As a result, field changes and valve transitions involving multiple coils 300, 310, 320 are coordinated within the timing tolerance required for reliable staging and collision in the collision region 200.

Some embodiments stream matrix data to drivers in real time; others pre-load short matrix segments into local buffers within driver stages to reduce communication latency. Limited local feedback loops within driver stages may regulate coil currents to commanded values, but the control system does not alter the high-level timing or sequence of matrix entries within a cycle based on plasma state. The entire cycle is treated as a scripted event, with the outcome evaluated only after completion for possible adjustments to future cycles.

### 1.7.4 External Sensor Suite

To support cycle-to-cycle adaptation and system monitoring, the control system 600-650 receives data from a sensor suite 640 that measures quantities external to the plasma interior. Sensors may include:

Magnetic field probes (Hall sensors, flux loops) located near coils and along channels, which provide information about the actual magnetic fields produced by the coil system and reveal deviations from expected patterns due to component aging, misalignment, or thermal effects.

Current and voltage sensors in driver circuits, which measure driver performance, including achieved current waveforms and switching behavior.

Fusion output detectors (neutron detectors, gamma-ray detectors) located outside the vacuum boundary, which provide per-cycle or per-burst indicators of reaction rates and energy release.

The sensor suite may omit or minimize direct measurements of plasma temperature, density, or position inside the micro-chambers or collision region, particularly at high temporal resolution. This avoids the need for fragile in-vessel diagnostics and high-bandwidth data acquisition. Instead, the system infers the effectiveness of staging and collision sequences from a combination of external field measurements, driver behavior, and aggregate fusion output.

### 1.7.5 Cycle-to-Cycle Adaptation

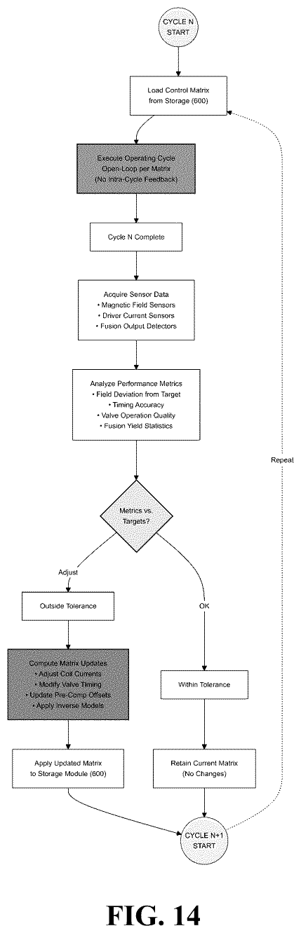

After one or more operating cycles, a learning and adaptation module analyzes the collected sensor data and compares observed behavior to desired targets or predicted outcomes, as illustrated in FIG. 14. Based on this analysis, the module may update control matrix entries, parameter sets, or high-level scheduling rules to improve performance over subsequent cycles.

For example, if magnetic field measurements indicate systematic offsets from desired values in certain regions, the adaptation module may adjust base or trim coil currents in the relevant time slices to restore correct chamber geometries or valve throat formation. If fusion output over a cycle window falls below the desired range, the module may alter staging timings, collision valve opening times, or injection parameters to increase the likelihood of higher-yield collisions.

Various adaptation strategies may be employed, including rule-based adjustments, numerical optimization algorithms, and machine-learning techniques. In all cases, adaptation operates at a time scale corresponding to many cycles; updated matrices are applied only at the start of subsequent cycles, preserving the open-loop nature of intra-cycle control.

Initial control matrices may be obtained, for example, by offline simulation of the coil and plasma dynamics, by empirical tuning during commissioning, or by solving optimization problems in which a cost function quantifies deviations from desired magnetic field trajectories, valve timing, or fusion output over one or more operating cycles.

In some embodiments, the adaptation module maintains or updates parametric models of coil and driver response, such as step responses or impulse responses derived from measurement. The control matrices may be computed or updated by convolving desired effective magnetic field trajectories at one or more spatial locations with inverse or approximate-inverse models of the actuator dynamics, thereby producing time-advanced drive commands that compensate for finite rise times, delays, and ringing in the hardware. This pre-calculation of lead/lag-adjusted command sequences allows the system to exploit the fine temporal resolution of the master clock to achieve effective timing alignment of magnetic topology changes with precision finer than the intrinsic electrical or mechanical time constants of individual components.

1.7.6 Distinction from Conventional Control

Conventional plasma control for steady-state magnetic confinement typically relies on continuous measurements of plasma parameters, including shape, position, density, and temperature, and uses real-time feedback loops to adjust coil currents, fueling, and auxiliary heating during operation. The control system described herein does not require such intra-cycle plasma feedback to achieve the designed operating regime.

Instead, the system employs pre-computed, matrix-encoded control sequences to drive the magnetic field topology through a series of planned configurations that define micro-chambers, micro-valves, and collision events. External measurements refine these sequences over many cycles, but individual cycles proceed according to programmed patterns even with cycle-to-cycle variability. This control philosophy is aligned with the statistical design of the fusion engine and the staged micro-chamber architecture.

### 1.8 Exhaust Handling and Optional Energy Recovery

### 1.8.1 Exhaust Valve Placements

As described in Section 1.3, certain micro-valves are employed in an exhaust role to route plasma and fusion products from staging or collision regions into exhaust regions 400 that are not part of the main chamber sequence. As illustrated in FIG. 15, exhaust valves 334 may be located at or near the central collision region 200, at selected downstream chambers, or at other points where plasma removal is desirable for thermal management, impurity control, or cycle reset.

Exhaust regions 400 include dedicated ducts, expansion volumes, or manifolds that are magnetically connected to exhaust valves 334. Within these regions 400, magnetic fields may be shaped to guide plasma toward material surfaces, heat-exchange structures, or diagnostic zones. Field topology and exhaust region geometry are selected to distribute heat loads, control particle fluxes, and facilitate coupling to external subsystems.

### 1.8.2 Engineered Weak Points and Instability Zones

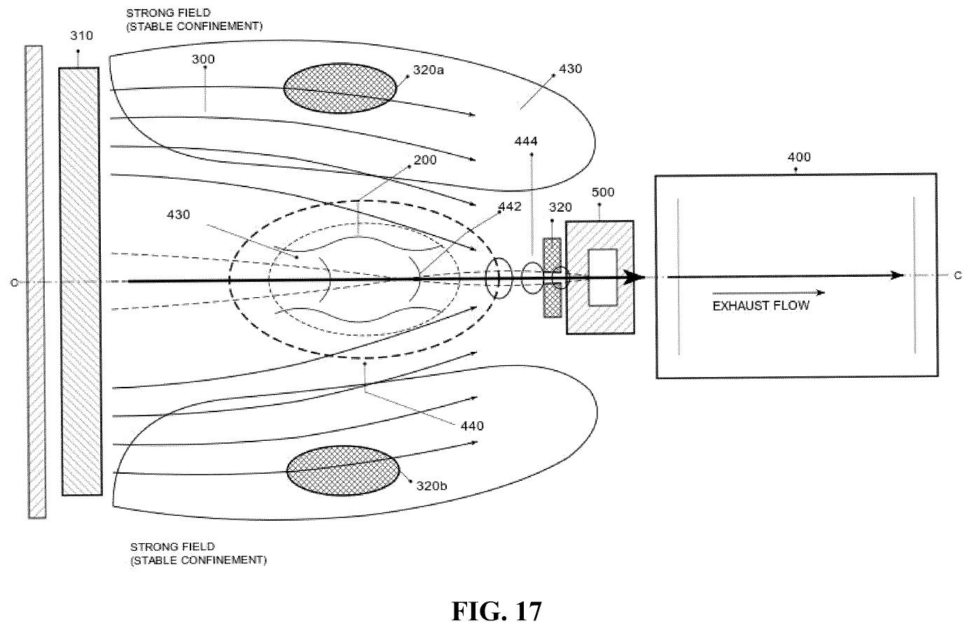

In some embodiments, the magnetic configuration near exhaust valves is designed to include controlled weak points or instability-prone regions that promote plasma outflow once an exhaust phase begins, as illustrated in FIG. 17. For example, local reductions in field strength, field line curvature, or shear may be used to encourage plasma detachment from the main confinement structures and to direct it along open field lines into exhaust regions when the corresponding valves are opened.

FIG. 17 illustrates a representative engineered field weak point or instability zone used during an exhaust phase. A micro-chamber or portion of the collision region 200 is bounded by base coils 300, driver coils 310, and trim coils 320a, 320b forming generally closed flux surfaces 430 in confinement mode. During an exhaust event, coordinated changes in the driver coils 310 and trim coils 320a, 320b create a localized region of reduced magnetic field strength and altered field line curvature, forming an open-flux channel 440 that connects the confinement region to an exhaust region 400. In the illustrated embodiment, the weak point appears as a narrow “nozzle” region where flux surfaces 430 are pulled apart to form a valve throat 442, and a collimated exhaust jet 444 is directed into the exhaust region 400 toward an energy-handling subsystem 500 or a recycling path 530. The rest of the confinement structure remains substantially closed, so that plasma preferentially detaches through the engineered weak point rather than leaking uniformly across the boundary.

In other embodiments, exhaust jets are formed primarily by the combination of pressure gradients and the topology of the open-flux channel, with the surrounding fields remaining substantially stable except in the vicinity of the valve throat. In both cases, time-gated exhaust valves create transient open paths along which plasma and fusion products are removed from the staging and collision regions in a controlled manner.

Engineered weak points are created and removed in a time-gated manner through the same general mechanism as transfer valves: coordinated driver and trim coil current changes alter the local field topology during the exhaust phase, then reverse during reset. The presence of controlled instability zones allows the system to relieve pressure and remove energy from selected regions without relying solely on slow diffusive processes or uncontrolled disruptions.

### 1.8.3 Coupling to Energy-Handling Systems

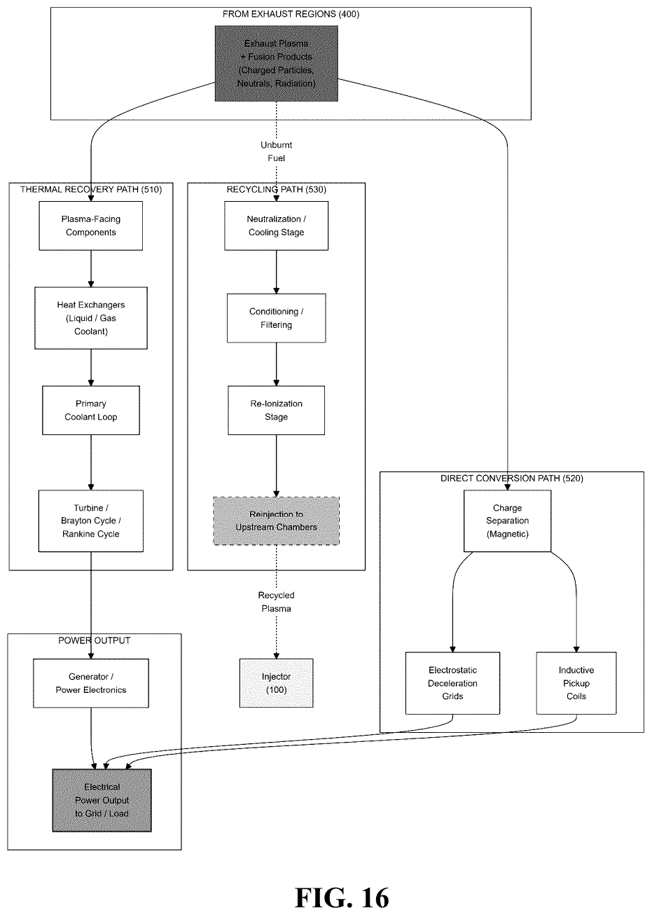

Exhaust regions 400 are coupled to energy-handling subsystems 500 appropriate for the anticipated mixture of charged particles, neutrals, and radiation, as illustrated in FIG. 16.

In representative embodiments, a thermal recovery subsystem 510 captures energy by flowing coolant through heat exchangers in contact with plasma-facing components. The resulting heat may be converted to electrical power using steam turbines, Brayton cycles, or other established thermal conversion technologies.

In some implementations, portions of the exhaust flow that contain predominantly charged particles may be directed through a direct conversion subsystem 520 suitable for partial direct energy conversion, such as electrostatic or inductive converters. The design and operation of such equipment follows established practices from fusion and high-temperature plasma research and is not essential to the definition of the staged micro-chamber and valve architecture.

Exhaust handling may also include pumping systems for maintaining vacuum conditions, impurity control mechanisms, and shielding structures 810 to protect external components from radiation. Specific choices vary between implementations and are not limiting.

### 1.8.4 Optional Plasma Recycling

In some embodiments, a portion of the plasma removed through exhaust valves 334 is not discarded but is routed through recycling paths 530 for reconditioning and reinjection into upstream regions.

For example, plasma from exhaust regions may be cooled, neutralized, re-ionized, or directly reinjected into early-stage chambers or injectors. This reduces the net fuel consumption and ionization energy required per unit of fusion output.

Recycling paths may include magnetic or electrostatic transport channels, gas handling and compression systems, or other suitable apparatus depending on the fuel type and desired purity level. The extent of recycling is adjustable based on system performance, fuel costs, and engineering trade-offs.

The presence or absence of recycling does not alter the essential staged micro-chamber and valve architecture but can improve overall efficiency in certain operating regimes.

### 1.9 Modular Implementation and Scaling

### 1.9.1 Module Definition

In some embodiments, the staged micro-chamber and valve fusion engine is implemented as a self-contained modular fusion unit 700 that includes one or more plasma channels 110, a central collision region 200, associated coil and driver hardware 300, 310, 320, a local control subsystem 600-650, and interfaces to shared energy-handling subsystems 500 and supervisory systems 720.

Each modular fusion unit 700 is designed to produce a nominal electrical output within a defined range at the target repetition rate. Representative output levels for a single unit 700 may range from several kilowatts to hundreds of kilowatts of net electrical power after internal consumption. Physical size is determined by channel lengths, collision region 200 and exhaust region 400 dimensions, and required spacing for coils 300, 310, 320, cooling, and shielding 810.

Each unit 700 may incorporate its own vacuum vessel or may share a common vacuum environment with other units 700, depending on integration choices. Within each unit 700, the control system 600-650 manages coil and valve operation, staging, collision scheduling, and local diagnostics. External systems provide bulk power, coolant, and supervisory commands such as operating mode and target output.

### 1.9.2 Module Array Configuration

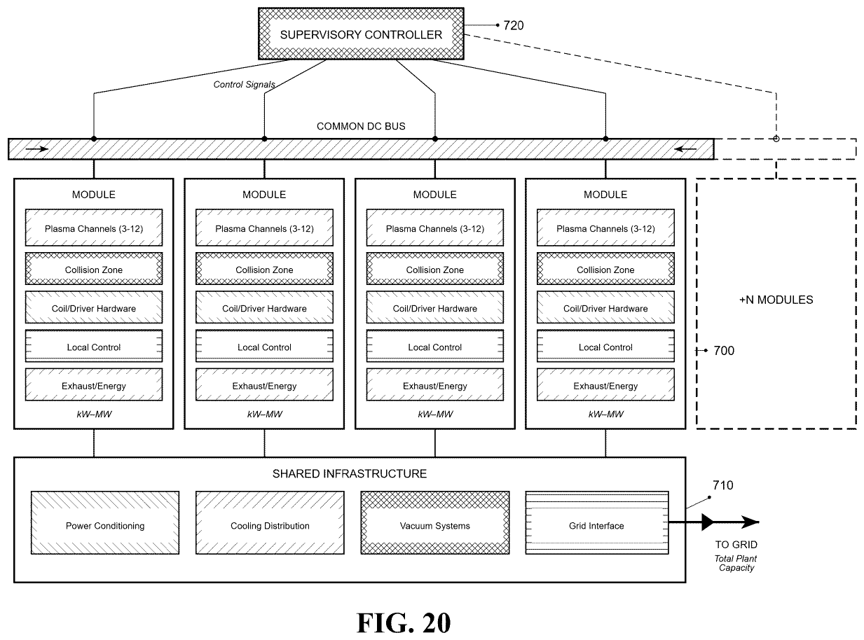

Multiple modular fusion units 700 may be combined to form a larger fusion power system, as illustrated in FIG. 20. Units 700 are connected electrically to shared infrastructure 710 such as a common DC bus or AC distribution system via appropriate power electronics, such as rectifiers, inverters, or DC/DC converters. This arrangement allows aggregate output power to be scaled by adding or removing units 700 and permits individual units to operate at different power levels as needed.

From a control perspective, a supervisory controller system 720 may coordinate unit operating states, including starting and stopping units 700, adjusting repetition rates, and selecting control matrices to meet overall power demand. Detailed staging and collision control within each unit 700 is handled by its local control system 600-650. Inter-unit synchronization of collision events is not strictly required for many applications, since energy-handling subsystems 500 are designed to accommodate the combined time-averaged output of all units 700.

Some implementations share common infrastructure 710 among units 700, such as coolant distribution, vacuum pumping, shielding 810, and safety systems. The modular architecture allows new units 700 to be added as capacity needs to grow or as improved designs become available, without requiring complete replacement of the installation.

### 1.9.3 Redundancy, Throttling, and Maintenance

The modular arrangement enables redundancy and flexible operating modes. For example, a system may include more modules than required for nominal output, operate at reduced repetition rates to extend component lifetime, and retain the ability to increase output temporarily by increasing repetition rates or activating additional modules.

Individual modules may be taken offline for maintenance, inspection, or upgrades while other modules continue operating, providing higher overall availability than a single large monolithic device. Within a module, individual channels may be disabled or operated at reduced duty cycle if local issues are detected, with the control system adjusting staging and collision patterns accordingly.

Throttling of power output may be achieved by varying the cycle repetition rate of individual modules, by modifying control matrices to alter per-cycle staging and collision parameters, or by temporarily disabling selected channels or collision events. These adjustments are made under supervisory control to match external grid demand or to respond to internal constraints such as thermal limits.

### 1.10 Startup, Calibration, and Alternative Embodiments

### 1.10.1 Calibration

Prior to routine operation, the coil system and micro-valve behavior are calibrated to align actual magnetic fields with design targets. Calibration procedures may include energizing base and driver coils in known patterns while measuring fields at multiple locations with the sensor suite, then adjusting control matrix entries or coil driver parameters to compensate for manufacturing tolerances, assembly variations, and initial alignment errors.

Micro-valve calibration may involve executing test sequences in which individual valves are commanded to open and close under low-power or low-density conditions while monitoring magnetic field changes and, optionally, small-signal plasma or gas responses. The timing and amplitude of driver and trim coil commands associated with each valve are tuned so that the desired throat formation and closure occur within specified time windows with acceptable repeatability.

Calibration data are stored in non-volatile memory and reused across many operating cycles. Periodic recalibration may be performed as needed to account for component aging, temperature-dependent behavior, or mechanical shifts.

### 1.10.2 Startup and Ramp-Up

A representative startup sequence proceeds as follows. First, the vacuum system establishes required pressure levels in the channels, collision region, and exhaust regions. Second, base coils are energized to establish guiding fields, and driver and trim coils are brought to initial bias currents consistent with confinement mode in all chambers.

Control matrices corresponding to conservative operating conditions, such as reduced repetition rate and modest staging, are loaded. Initial low-power cycles are executed with limited or no plasma injection to verify coil and driver behavior. Once baseline operation is confirmed, plasma injection is enabled at low density, and staging and collision sequences are exercised while monitoring external diagnostics for signs of proper operation, such as expected magnetic field waveforms and initial fusion reaction indicators.

As confidence is gained, the control system may increase plasma density, expand staging sequences, and raise repetition rates according to predefined ramp-up profiles. Monitoring continues, and matrices are adjusted as needed. When target operating conditions and output levels are reached, the system transitions to steady-state operation with ongoing cycle-to-cycle adaptation.

### 1.10.3 Auxiliary Drivers

Some embodiments integrate auxiliary drivers, such as electron beams, ion beams, or laser pulses, to deliver additional energy to the collision region during or after the convergent event. Such drivers are synchronized with the collision phase using the same master timing infrastructure as the coil and valve control and may be treated as additional actuators in the control matrices.

For example, an auxiliary electron beam driver, such as disclosed in co-pending U.S. Provisional Patent Application No. 63/735,936, may be triggered to deposit energy into the interaction volume at or shortly after the peak plasma convergence time, with the goal of enhancing fusion reaction rates in some operating regimes.

Detailed design of such drivers, their plasma coupling, and related control logic may be disclosed in separate applications and does not alter the fundamental staged micro-chamber and valve architecture described herein.

### 1.10.4 Fuel Cycle and Scale Variants

The systems and methods described herein are compatible with various fusion fuel combinations, including but not limited to D-T, D-D, and advanced fuels such as D-He3 and p-B11, subject to appropriate plasma parameter choices and energy-handling provisions. Different fuels may favor different collision geometries, staging strategies, or auxiliary driver configurations.

Scale variants may range from relatively small experimental devices that demonstrate micro-chamber and valve behavior, through medium-scale modules suitable for distributed power applications, to larger module assemblies for grid-scale plants. Geometric scale changes may entail corresponding adjustments in coil sizes, channel lengths, repetition rates, and energy-handling systems, but do not fundamentally alter the staged micro-chamber and valve principles underlying the fusion engine.

Numerous modifications and alternative embodiments will be apparent to those of ordinary skill in the art in view of this disclosure. Unless otherwise expressly limited by the claims, the scope of the invention encompasses such variations, provided that the essential features of staged magnetic micro-chambers, dynamic magnetic micro-valves, and statistically oriented operation are maintained.

What is claimed is:

1. A fusion energy system comprising:
a plurality of plasma acceleration channels, each channel defining a plasma transport axis extending from an upstream injection region toward a central collision region;
for each plasma acceleration channel, a plurality of magnetic micro-chambers arranged in series along the plasma transport axis, each magnetic micro-chamber being defined principally by closed or quasi-closed magnetic flux surfaces configured to confine a plasma packet during a confinement phase;
a magnetic field system comprising a plurality of base coils, driver coils, and trim coils arranged with respect to the plasma acceleration channels and configured, when energized, to:
generate the closed or quasi-closed magnetic flux surfaces that define the magnetic micro-chambers during the confinement phase; and
selectively reconfigure a portion of the magnetic flux surfaces at a boundary of a given magnetic micro-chamber to form a transient open-flux channel between the given magnetic micro-chamber and an adjacent region during a valve-open phase;
a control system operatively coupled to the magnetic field system and configured to drive the base coils, driver coils, and trim coils according to pre-defined time-dependent control sequences so that, during the valve-open phase, plasma confined in the given magnetic micro-chamber is expelled through the transient open-flux channel as a collimated plasma jet into the adjacent region; and
the central collision region magnetically coupled to terminal ones of the magnetic micro-chambers of the plurality of plasma acceleration channels and configured to receive collimated plasma jets from the terminal magnetic micro-chambers during coordinated valve-open phases, such that the collimated plasma jets converge within a localized interaction volume to produce fusion reactions.

2. The system of claim 1, wherein each plasma acceleration channel comprises at least three magnetic micro-chambers arranged in series.

3. The system of claim 1, wherein an axial length of each magnetic micro-chamber along the plasma transport axis is between about 1 centimeter and about 20 centimeters, and a transverse dimension of each magnetic micro-chamber is between about 0.5 centimeters and about 5 centimeters.

4. The system of claim 1, wherein the transient open-flux channel formed during the valve-open phase has an effective cross-sectional area that is less than about thirty-five percent of a cross-sectional area of the corresponding magnetic micro-chamber, such that plasma is expelled as a narrow, directed jet.

5. The system of claim 1, wherein the valve-open phase at a given magnetic micro-chamber boundary has a duration in a range from about 10 nanoseconds to about 10 microseconds.

6. The system of claim 1, wherein the collimated plasma jets produced during the valve-open phases have directed velocities along the plasma transport axes of at least about 10 kilometers per second.

7. The system of claim 1, wherein the control system comprises:
a control matrix storage module containing one or more control matrices that index actuators, including coils and valve abstractions, against discrete time slices within an operating cycle, each control matrix entry specifying a target value or state for a corresponding actuator at a corresponding time slice;
a timing distribution network configured to distribute a master clock signal to a plurality of coil driver channels with bounded skew; and
a cycle execution module configured to read entries of the one or more control matrices in synchronization with the master clock signal and to issue commands to the coil driver channels such that valve-open phases and associated coil transitions across multiple magnetic micro-chambers occur in predetermined temporal relationships,
wherein entries of the one or more control matrices encode time-advanced drive commands that compensate for measured or modeled response times of the coils and driver hardware so that effective magnetic topology changes at specified spatial locations occur within targeted timing windows.

8. The system of claim 1, wherein the control system is configured to execute each operating cycle according to the pre-defined time-dependent control sequences without relying on intra-cycle measurement of plasma temperature, plasma density, or plasma position within the magnetic micro-chambers or the central collision region.

9. The system of claim 8, wherein the control system is further configured to:
receive, between operating cycles, diagnostic data from external sensors including at least one of magnetic field sensors, driver current sensors, and fusion output detectors; and
adjust one or more of the pre-defined time-dependent control sequences for subsequent operating cycles based at least in part on the diagnostic data, thereby implementing cycle-to-cycle adaptation while maintaining open-loop control with respect to plasma state during each operating cycle.

10. The system of claim 1, wherein the central collision region has a linear dimension less than about one millimeter, and the control system is configured to coordinate valve-open phases at terminal magnetic micro-chambers of the plurality of plasma acceleration channels so that peak intensities of collimated plasma jets from different channels overlap in the central collision region within a temporal window in a range from about 1 nanosecond to about 1 microsecond.

11. The system of claim 1, wherein the system is capable of being operated in repeated operating cycles at a repetition rate of at least about 1 operating cycle per second, and is configured such that aggregate fusion energy output over a plurality of the repeated operating cycles exceeds aggregate energy input to the fusion energy system over the plurality of operating cycles.

12. The system of claim 11, wherein the control system is configured to adjust the repetition rate of the operating cycles over a range spanning at least one order of magnitude.

13. The system of claim 11, wherein net positive aggregate fusion energy output is achievable without requiring that a majority of individual operating cycles each produce net-positive fusion energy output, including operating regimes in which more than 90 percent of individual operating cycles do not themselves produce fusion energy output greater than an energy input to the fusion energy system for the respective operating cycles.

14. The system of claim 1, further comprising one or more exhaust regions magnetically coupled to selected magnetic micro-chambers or to the central collision region by exhaust-type transient open-flux channels formed by corresponding exhaust valves, the exhaust regions being arranged to receive plasma and fusion products during an exhaust phase of the operating cycle.

15. The system of claim 14, wherein at least a portion of the exhaust regions are thermally coupled to energy-handling subsystems configured to convert thermal energy carried by exhaust plasma and fusion products into usable heat or electrical power.

16. The system of claim 14, further comprising recycling paths configured to route a fraction of exhaust plasma for reinjection into upstream regions of one or more plasma acceleration channels.

17. The system of claim 14, wherein magnetic configurations near the exhaust valves include engineered weak points configured to promote plasma detachment and outflow when the exhaust valves are opened.

18. The system of claim 1, implemented as a modular fusion unit configured to operate in parallel with one or more additional modular fusion units on a common electrical or thermal bus, each modular fusion unit comprising its own plurality of plasma acceleration channels, coil and driver hardware, local control system, and exhaust regions, such that aggregate power output of a plant is scalable by adding or removing modular fusion units.

19. The system of claim 1, wherein the plurality of plasma acceleration channels comprises between three and twelve plasma acceleration channels arranged around the central collision region.

20. The system of claim 1, wherein:
the base coils are configured to provide a background guiding magnetic field along the plasma transport axes;
the driver coils are positioned at boundaries between adjacent magnetic micro-chambers and are configured to generate axial field gradients defining the magnetic micro-chamber boundaries; and
the trim coils are configured to generate localized field perturbations for fine shaping of flux surfaces and for forming valve throats during valve-open phases.

21. The system of claim 1, further comprising guide structures surrounding the plasma acceleration channels, the guide structures having internal apertures at least five times larger than a transverse dimension of plasma packets confined within the magnetic micro-chambers.

22. The system of claim 1, wherein the control system is configured to operate the magnetic micro-chambers in a pipelined fashion such that, at a given time within an operating cycle, different plasma packets occupy different magnetic micro-chambers along a plasma acceleration channel, each at a different phase of a confinement-valve-transfer sequence.

23. The system of claim 1, wherein the transient open-flux channel formed during the valve-open phase comprises a localized, time-gated weak point or breach zone in the magnetic flux surfaces at the boundary of the given magnetic micro-chamber.

24. A method of generating fusion energy, comprising:
providing a plurality of plasma acceleration channels, each channel including a plurality of magnetic micro-chambers arranged in series along a plasma transport axis, and a central collision region magnetically coupled to terminal ones of the magnetic micro-chambers;
in an operating cycle, injecting plasma into an upstream magnetic micro-chamber of at least one of the plasma acceleration channels;
during a confinement phase for a given magnetic micro-chamber, energizing a magnetic field system to generate closed or quasi-closed magnetic flux surfaces that confine the plasma within the given magnetic micro-chamber as a plasma packet;
during a valve-open phase for a boundary of the given magnetic micro-chamber, transiently reconfiguring the magnetic field system to form an open-flux channel between the given magnetic micro-chamber and an adjacent region, while maintaining confinement elsewhere in the given magnetic micro-chamber;
expelling at least a portion of the confined plasma from the given magnetic micro-chamber through the open-flux channel as a collimated plasma jet into the adjacent region;
repeating the confinement and expelling steps through successive pairs of magnetic micro-chambers in at least one of the plasma acceleration channels so that the plasma packet is staged through multiple magnetic micro-chambers to a terminal magnetic micro-chamber adjacent to the central collision region; and
coordinating valve-open phases of terminal magnetic micro-chambers of a plurality of the plasma acceleration channels so that collimated plasma jets from the terminal magnetic micro-chambers converge within a localized interaction volume in the central collision region and produce fusion reactions,
wherein the energizing, reconfiguring, expelling, repeating, and coordinating steps in each operating cycle are executed according to pre-defined time-dependent control sequences without relying on intra-cycle measurement of plasma temperature, plasma density, or plasma position within the magnetic micro-chambers or the central collision region.

25. The method of claim 24, wherein coordinating the valve-open phases comprises timing the valve-open phases such that peak intensities of the collimated plasma jets from different plasma acceleration channels overlap in the localized interaction volume within a temporal window between about 1 nanosecond and about 1 microsecond.

26. The method of claim 24, wherein repeating the confinement and expelling steps comprises operating at least some of the magnetic micro-chambers in a pipelined manner such that, during a given portion of the operating cycle, different plasma packets occupy different magnetic micro-chambers along a plasma acceleration channel.

27. The method of claim 24, further comprising, between operating cycles:
receiving diagnostic data from external sensors including at least one of magnetic field sensors, driver current sensors, and fusion output detectors; and
adjusting one or more of the pre-defined time-dependent control sequences for subsequent operating cycles based at least in part on the diagnostic data, while maintaining open-loop execution with respect to plasma state during each operating cycle.

28. The method of claim 24, further comprising:
repeating the operating cycle at a repetition rate of at least about 1 operating cycle per second; and
determining net fusion energy output based on aggregate fusion energy produced over a plurality of the repeated operating cycles and aggregate energy input over the plurality of operating cycles, such that net positive energy output is obtained notwithstanding variability in fusion yield among individual operating cycles.

29. A magnetic plasma transfer system comprising:
a first magnetic confinement region and a second magnetic confinement region arranged in series along a plasma path;
a coil array configured, when energized in a confinement mode, to generate closed or quasi-closed magnetic flux surfaces that confine plasma substantially within the first magnetic confinement region and substantially prevent plasma flow into the second magnetic confinement region along the plasma path; and
a control system configured to transiently modify currents in selected coils of the coil array to enter a valve-open mode in which a localized open-flux channel is formed between the first magnetic confinement region and the second magnetic confinement region, while closed or quasi-closed magnetic flux surfaces are maintained elsewhere around at least the first magnetic confinement region,
wherein, in the valve-open mode, a pressure differential between the first magnetic confinement region and the second magnetic confinement region drives plasma flow through the localized open-flux channel as a collimated plasma jet from the first magnetic confinement region into the second magnetic confinement region.

30. The system of claim 29, wherein the localized open-flux channel has an effective cross-sectional area that is less than about thirty-five percent of a cross-sectional area of the first magnetic confinement region.

31. The system of claim 29, wherein the localized open-flux channel comprises a time-gated weak point or breach zone in the magnetic flux surfaces, the weak point or breach zone being created by the transient modification of currents in the selected coils and removed when the currents are restored to confinement-mode values.

32. A control system for a pulsed plasma device comprising:
a control matrix storage module configured to store one or more control matrices, each control matrix including entries that index actuators associated with the pulsed plasma device against discrete time slices within an operating cycle, each entry specifying a target value or state for a corresponding actuator at a corresponding time slice;
a timing distribution network configured to generate and distribute a master clock signal to a plurality of actuator driver channels with bounded skew;
a cycle execution module configured to, for each operating cycle, read entries of a selected control matrix in synchronization with the master clock signal and issue corresponding commands to the actuator driver channels such that the actuators follow pre-defined time-dependent trajectories during the operating cycle; and
an adaptation module configured to receive diagnostic data from external sensors between operating cycles and to adjust one or more of the control matrices for subsequent operating cycles based at least in part on the diagnostic data,
wherein the control system is configured such that, during execution of each operating cycle, the actuator commands are not altered in response to intra-cycle measurements of plasma temperature, plasma density, or plasma position within the pulsed plasma device.

33. The control system of claim 32, wherein the actuators comprise at least one of base coils, driver coils, trim coils, and valve abstractions associated with magnetic micro-chambers of a staged plasma device, and wherein at least some entries of the control matrices encode transitions between confinement modes and valve-open modes of the magnetic micro-chambers.

34. The control system of claim 32, wherein:
the timing distribution network is configured to provide synchronization accuracy between actuator driver channels on the order of sub-nanosecond intervals across at least a portion of the operating cycle; and
a temporal resolution of the control matrices and the master clock enables specification of actuator command timing with picosecond-scale granularity, and entries of the control matrices encode time-advanced drive commands that compensate for measured or modeled response times of coils and driver hardware so that effective magnetic topology changes at specified spatial locations occur within targeted convergence windows.

35. The control system of claim 32, wherein the adaptation module is configured to compute or update the control matrices by convolving desired effective magnetic field trajectories with inverse or approximate-inverse models of actuator dynamics, thereby producing time-advanced drive commands that compensate for finite rise times, delays, and ringing in actuator hardware.

36. A plasma energy recovery system comprising:
a magnetic micro-chamber configured to confine plasma within quasi-closed magnetic flux surfaces during a confinement phase;
a magnetic field system comprising a plurality of coils arranged with respect to the magnetic micro-chamber and configured, when energized in an exhaust phase, to form a transient open-flux channel between an interior of the magnetic micro-chamber and an exhaust region;
an engineered field weak point adjacent to the transient open-flux channel, the engineered field weak point being configured to promote plasma detachment from the quasi-closed magnetic flux surfaces and outflow into the exhaust region when the exhaust phase begins; and
an energy recovery structure coupled to the exhaust region and configured to receive plasma and fusion products directed through the transient open-flux channel as a time-gated plasma jet,
wherein the transient open-flux channel is formed by coordinated changes in currents in selected coils of the magnetic field system that reconfigure a portion of the magnetic flux surfaces at a boundary of the magnetic micro-chamber from the confinement phase to an exhaust valve-open phase.

37. The plasma energy recovery system of claim 36, wherein the energy recovery structure comprises at least one of a thermal heat exchanger, an electrostatic direct energy converter, and an inductive energy converter.

38. The plasma energy recovery system of claim 36, implemented in combination with a fusion energy system comprising a plurality of plasma acceleration channels and a central collision region, wherein the coordinated changes in currents in the selected coils use the same magnetic topology reconfiguration mechanism that forms transient open-flux channels between adjacent magnetic micro-chambers in the fusion energy system.
